(19) United States
(12) Patent Application Publication
(10) Pub. No.: US 2015/0228436 A1
(43) Pub. Date: Aug. 13, 2015

(54) FUSES AND FUSE PROGRAMMING METHODS

(71) Applicant: Infineon Technologies AG, Neubiberg (DE)

(72) Inventors: Franz Ungar, Oedenpullach (DE); Gunther Lehmann, Holzkirchen (DE); Armin Fischer, Muenchen (DE); Alexander Von Glasow, Riemerling (DE); Sascha Siegler, Unterhaching (DE)

(21) Appl. No.: 14/609,463

(22) Filed: Jan. 30, 2015

Related U.S. Application Data
(60) Provisional application No. 61/937,665, filed on Feb. 10, 2014.

(51) Int. Cl. H01H 85/46

(52) U.S. Cl. CPC H01H 85/46

(57) ABSTRACT

A fuse may be provided, which may include: a first fuse link; a second fuse link coupled in series to the first fuse link; and a connection element coupled between the first and second fuse links and disposed in the same level as the first and second fuse links.

### CROSS-REFERENCE TO RELATED APPLICATIONS

This application claims priority of U.S. provisional application Ser. No. 61/937,665, filed on Feb. 10, 2014, which is hereby incorporated herein by reference in its entirety.

### TECHNICAL FIELD

Various aspects relate to fuses and fuse programming methods.

### BACKGROUND

A fuse may be included and/or integrated in a device that may, for example, be used in various technologies, including but not limited to n-type metal-oxide-semiconductor (NMOS), p-type metal-oxide-semiconductor (PMOS), and complementary metal-oxide-semiconductor (CMOS) technologies.

A fuse may include a fuse link, e.g. an electrical link and/or interconnect. Programming a fuse may include, or may consist of, selectively disconnecting (e.g. rupturing) the fuse link, e.g. electrical link and/or interconnect, of the fuse. A fuse may be determined (e.g. by means of a sensing circuit) to be a programmed fuse (e.g. a fuse in which the electrical link may be disconnected) or an unprogrammed fuse (e.g. a fuse in which the electrical link may be connected). A programmed fuse may be erroneously determined as being an unprogrammed fuse, for example if a resistance of the fuse after programming is smaller than some threshold or decision level.

### SUMMARY

In accordance with various embodiments, a fuse is provided, which may include: a first fuse link; a second fuse link coupled in series to the first fuse link; and a connection element coupled between the first and second fuse links and disposed in the same level as the first and second fuse links.

In accordance with various embodiments, a fuse is provided, which may include: a first fuse link; and a second fuse link coupled in series to the first fuse link, wherein at least one of the first and second fuse links includes polysilicon.

In accordance with various embodiments, a fuse is provided, which may include: a first fuse link; a second fuse link coupled in series to the first fuse link; and at least one non-fusable connection element coupled between the first and second fuse links, the connection element having a non-minimal feature size and being disposed in a metallization level at least one of above and below the first and second fuse links.

In accordance with various embodiments, a fuse is provided, which may include: a first fuse link; a second fuse link coupled in series to the first fuse link, wherein the first and second fuse links are configured to have a lateral current flow; and a connection element coupled between the first and second fuse links, the connection element being disposed in a metallization level at least one of above and below the first and second fuse links.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 shows a schematic plan view of a conventional fuse.

FIG. 2 shows a cross-sectional view of a portion of a fuse link.

FIG. 3 shows cumulative resistance distributions of unprogrammed and programmed fuses.

FIG. 4A and FIG. 4B show an example where two fuses are used to indicate a value of one bit.

FIG. 5 shows a schematic plan view of a fuse.

FIG. 6 shows a programming pulse and a programming current as a function of time.

FIG. 7 shows cumulative resistance distributions of each of two fuse links in the programmed states as well as a cumulative resistance distribution of a series coupling of the fuse links in the programmed state.

FIG. 8A to FIG. 8C show schematic plan views of fuses, each including a first terminal region and a second terminal region.

FIG. 9 shows a schematic plan view of a fuse including at least one connection element coupled between first and second fuse links.

FIG. 10 shows a schematic plan view of a fuse including first and second fuse links, a first terminal region, a second terminal region, and at least one connection element.

FIG. 11A and FIG. 11B show schematic plan views of fuses including first and second fuse links at least one connection element, first and second terminal regions, and first and second terminal contacts coupled to the first and second terminal regions.

FIG. 12 shows a schematic plan view of a fuse element including a fuse and a fuse operating circuit.

FIG. 13A to FIG. 13C show schematic plan views of fuse elements including a programming transistor.

FIG. 14 shows a schematic plan view of a fuse array.

FIG. 15 to FIG. 19 show methods for programming a fuse.

### DESCRIPTION

The following detailed description refers to the accompanying drawings that show, by way of illustration, specific details and aspects in which the invention may be practised. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects can be combined with one or more other aspects to form new aspects. Various aspects are described for structures or devices, and various aspects are described for methods. It may be understood that one or more (e.g. all) aspects described in connection with structures or devices may be equally applicable to the methods, and vice versa.

The word “exemplary” is used herein to mean “serving as an example, instance, or illustration”. Any aspect or design described herein as “exemplary” is not necessarily to be construed as preferred or advantageous over other aspects or designs.

The word “over”, used herein to describe forming a feature, e.g. a layer “over” a side or surface, may be used to mean that the feature, e.g. the layer, may be formed “directly on”, e.g. in direct contact with, the implied side or surface. The word “over”, used herein to describe forming a feature, e.g. a layer “over” a side or surface, may be used to mean that the feature, e.g. the layer, may be formed “indirectly on” the implied side or surface with one or more additional layers being arranged between the implied side or surface and the formed layer.

In like manner, the word “cover”, used herein to describe a feature disposed over another, e.g. a layer “covering” a side or surface, may be used to mean that the feature, e.g. the layer, may be disposed over, and in direct contact with, the implied side or surface. The word “cover”, used herein to describe a feature disposed over another, e.g. a layer “covering” a side or surface, may be used to mean that the feature, e.g. the layer, may be disposed over, and in indirect contact with, the implied side or surface with one or more additional layers being arranged between the implied side or surface and the covering layer.

The terms “coupled” and/or “electrically coupled” and/or “connected” and/or “electrically connected”, used herein to describe a feature being connected to at least one other implied feature, are not meant to mean that the feature and the at least one other implied feature must be directly coupled or connected together; intervening features may be provided between the feature and at least one other implied feature.

Directional terminology, such as e.g. “upper”, “lower”, “top”, “bottom”, “left-hand”, “right-hand”, etc., may be used with reference to the orientation of figure(s) being described. Because components of the figure(s) may be positioned in a number of different orientations, the directional terminology is used for purposes of illustration and is in no way limiting. It is to be understood that structural or logical changes may be made without departing from the scope of the invention.

A fuse may include a fuse link, e.g. an electrical link and/or interconnect, that may be selectively disconnected (e.g. by means of blowing, cutting, rupturing and/or removing material). A fuse may be configured as an electrically programmable fuse (electrical fuse, e-fuse). A fuse may be configured as at least one of a polysilicon fuse, a metal fuse, and a cavity fuse, although other fuse configurations may be possible as well.

A fuse (e.g. e-fuse) may be used in various technologies, including but not limited to n-type metal-oxide-semiconductor (NMOS), p-type metal-oxide-semiconductor (PMOS), and complementary metal-oxide-semiconductor (CMOS) technologies.

A fuse (e.g. e-fuse) may be used in a plurality of applications, e.g. in at least one of the above-mentioned technologies. For example, a fuse may be used for identification (e.g. chip identification), storage (e.g. storage of customer specific security strings), parameter trimming (e.g. analog parameter trimming), locking (e.g. electrical locking of chips), storage and update of firmware, and enabling or disabling of features, although other applications may be possible as well.

A fuse may be included and/or integrated in a device that may, for example, be used in at least one of the above-mentioned technologies. For example, a fuse may be included and/or integrated in at least one of a logic device (e.g. a CMOS logic device), a memory device (e.g. a PMOS memory device), and a chip (e.g. an integrated chip, e.g. an application specific integrated circuit), although a fuse may be included and/or integrated in other devices as well.

At least one fuse may be included and/or integrated in a device (e.g. a chip). The number of fuses included and/or integrated in a device (e.g. a chip, e.g. an integrated chip) may be in the range from a few fuses (e.g. less than or equal to about 100 fuses, e.g. less than or equal to about 50 fuses, e.g. less than or equal to about 10 fuses) to several thousand fuses (e.g. greater than or equal to about 1000 fuses, e.g. greater than or equal to about 3000 fuses, e.g. greater than or equal to about 5000 fuses).

The number of fuses included and/or integrated in a device (e.g. a chip) may depend on the application. For example, the number of fuses included and/or integrated in a device (e.g. a chip) may depend on whether the fuse is used for identification (e.g. chip identification), storage (e.g. storage of customer specific security strings), parameter trimming (e.g. analog parameter trimming), locking (e.g. electrical locking of chips), storage and update of firmware, and enabling or disabling of features, although other applications may affect, at least in part, the number of fuses included and/or included in a device (e.g. a chip).

A plurality of fuses may be included and/or integrated in a device (e.g. a chip). The plurality of fuses may be arranged as a one-dimensional structure (e.g. a fuse bank) or as a two-dimensional array (e.g. a fuse array). In some examples, the plurality of fuses may be arranged in a three-dimensional structure. The arrangement of a plurality of fuses (e.g. as a one-, two-, or three-dimensional structure or array) may depend at least in part on the application. For example, the arrangement of a plurality of fuses may depend at least in part on whether the plurality of fuses is used for identification (e.g. chip identification), storage (e.g. storage of customer specific security strings), parameter trimming (e.g. analog parameter trimming), locking (e.g. electrical locking of chips), storage and update of firmware, and enabling or disabling of features, although other applications may affect, at least in part, the arrangement of a plurality of fuses. For example, a plurality of fuses may be arranged as a two-dimensional array (e.g. fuse array) in case the plurality of fuses is used in memory e.g. static random-access memory (SRAM) macros.

A fuse may be programmed, e.g. by means of a programming pulse. The programming pulse may include, or may be, a programming current pulse and/or a programming voltage pulse.

Programming a fuse may include, or may consist of, changing a state of the fuse from an unprogrammed state to a programmed state.

Programming a fuse may include, or may consist of, rupturing at least a part or a portion (e.g., a fuse link) of the fuse and/or removing material from at least a part or a portion (e.g., a fuse link) of the fuse. Alternatively, or additionally, programming a fuse may include, or may consist of, changing a structure (e.g. micro-structure) of the fuse (e.g. of a fuse link of the fuse).

Programming a fuse may include, or may consist of, changing a resistance (e.g. ohmic and/or electrical resistance) of the fuse from a first resistance value (e.g. first ohmic resistance value) to a second resistance value (e.g. second ohmic resistance value). The first resistance value (e.g. first ohmic resistance value) may correspond to the unprogrammed state of the fuse while the second resistance value (e.g. second ohmic resistance value) may correspond to the programmed state of the fuse. The second resistance value may be larger than the first resistance value. For example, the second resistance value may be more than twice the first resistance value, e.g. more than three times the first resistance value, e.g. more than five times the first resistance value, e.g. more than ten times the first resistance value, e.g. more than twenty times the first resistance value, e.g. more than fifty times the first resistance value.

Programming a fuse may include, or may consist of, changing a resistance of the fuse from a first ohmic state to a second ohmic state. The second ohmic state may, for example, have a larger resistance than the first ohmic state. The first ohmic state may be referred to as a low-ohmic state and the second ohmic state may be referred to as a high-ohmic state. The first ohmic state (e.g. low-ohmic state) may correspond to the unprogrammed state of the fuse while the second ohmic state (e.g. high-ohmic state) may correspond to the programmed state of the fuse.

An unprogrammed fuse may be distinguished from a programmed fuse by means of sensing a resistance of the fuse, e.g. relative to a threshold or decision level. The resistance of a fuse may, for example, be sensed (e.g. relative to a threshold or decision level) by means of a sensing circuit, e.g. a sense amplifier. The sensing circuit may be coupled (e.g. electrically and/or communicatively coupled) to the fuse.

Programming a fuse may be irreversible. For example, as described above, programming a fuse may include, or may consist of, at least one of rupturing at least a part or a portion (e.g., a fuse link) of the fuse, removing material from at least a part or a portion of the fuse, and changing a structure (e.g. micro-structure) of the fuse (e.g., of a fuse link of the fuse). Accordingly, it may not be possible to mend a fuse after rupturing, removing material from, and/or changing a structure (e.g. micro-structure) of the fuse. In other words, a fuse may include, or may be, a one-time programmable fuse (e.g. one-time programmable e-fuse).

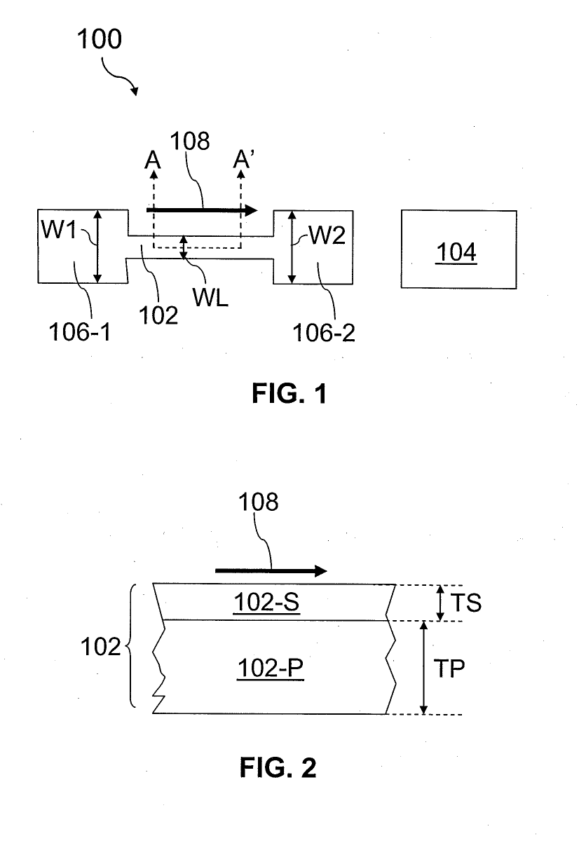

FIG. 1 shows a schematic plan view of a conventional fuse 100.

The fuse 100 may include a fuse link 102, which may be coupled (e.g. electrically coupled) between a first terminal region 106-1 and a second terminal region 106-2. The fuse 100 may include a programming circuit 104, which may be coupled (e.g. electrically coupled) to the first terminal region 106-1 and/or the second terminal region 106-2. The programming circuit 104 may include, or may be, a programming transistor.

The first terminal region 106-1 and the second terminal region 106-2 may include, or may be, a cathode region and an anode region, respectively, or vice versa.

A current (e.g. electrical current) may flow through the fuse 100. In the example shown in FIG. 1, the current may flow from the first terminal region 106-1 to the second terminal region 106-2 through the fuse link 102. This is indicated in FIG. 1 as a current flow direction 108. In another example, however, the current may flow in an opposite direction, namely, from the second terminal region 106-2 to the first terminal region 106-1 through the fuse link 102.

A cross-sectional area of the first terminal region 106-1 may be larger than a cross-sectional area of the fuse link 102. Similarly, a cross-sectional area of the second terminal region 106-2 may be larger than a cross-sectional area of the fuse link 102. As used herein, a cross-sectional area may refer to an area of a transverse cross-section, e.g. a cross-section that may be at least substantially perpendicular to the current flow direction 108.

As shown in FIG. 1, a width WL of the fuse link 102 may be narrower than a width W1 of the first terminal region 106-1 and a width W2 of the second terminal region 106-2.

As described above, the fuse 100 may be programmed, e.g. by means of a programming pulse, which may include, or may be, a programming current pulse and/or programming voltage pulse. The programming pulse (e.g. programming current and/or voltage pulse) may be provided by the programming circuit 104 (e.g. programming transistor). For example, a programming voltage pulse (e.g. a pulsed programming voltage) may be applied across the first and second terminal regions 106-1, 106-2. This may induce a current flow between the first and second terminal regions 106-1, 106-2 through the fuse link 102. The programming voltage pulse may be of a predetermined time duration and/or a predetermined peak voltage.

The fuse 100 may be programmed by at least one programming mode. The at least one programming mode may include, or may be, at least one of electromigration mode programming and rupture mode programming.

The programming mode used for programming the fuse 100 may depend, at least in part, on a design of the fuse link 102 (e.g. a dimension of and/or a material included in the fuse link 102), a dimension of the programming circuit 104 (e.g. an area occupied by the programming circuit 104) and/or programming parameters (e.g. a duration and/or a maximum amplitude of the programming current and/or voltage pulse).

In rupture mode programming, at least a part or a portion of the fuse link 102 may be ruptured or broken, e.g. as a consequence of programming the fuse 100. In other words, the fuse link 102 may be ruptured after programming the fuse 100. Accordingly, the coupling (e.g. electrical coupling) between the first and second terminal regions 106-1, 106-2 may be broken after rupture mode programming of the fuse 100.

In electromigration mode programming, at least a part or a portion of the fuse link 102 may still be intact after programming the fuse 100. The description that follows provides examples of electromigration mode programming of the fuse 100. However, the examples described are illustrative and not meant to be limiting. The description may be analogously applied to rupture mode programming of the fuse 100.

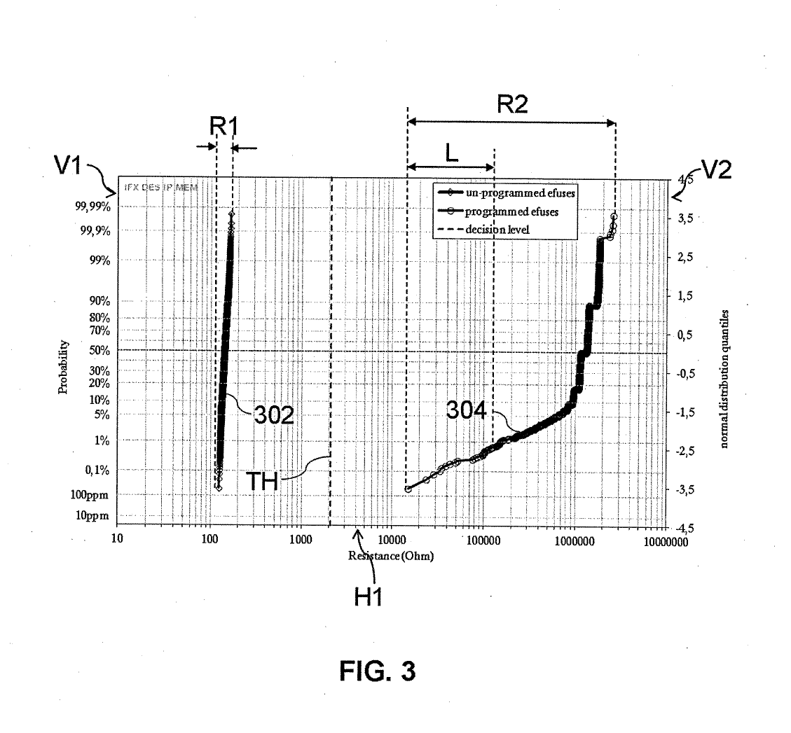

FIG. 2 shows a cross-sectional view of a portion of the fuse link 102 shown in FIG. 1 along the line A-A′.

The fuse link 102 may include a polysilicon layer 102-P and a silicide layer 102-S, which may be disposed at a surface of the polysilicon layer 102-P. In the example shown in FIG. 2, the silicide layer 102-S may be disposed at an upper surface of the polysilicon layer 102-P. However, alternatively or additionally, the silicide layer 102-S may be disposed at a lower surface and/or one or more sidewalls of the polysilicon layer 102-P.

As shown in FIG. 2, a thickness TS of the silicide layer 102-S may be smaller than a thickness TP of the polysilicon layer 102-P. A resistance (e.g. ohmic or electrical resistance) of the silicide layer 102-S of the fuse link 102 may be smaller than a resistance (e.g. ohmic or electrical resistance) of the polysilicon layer 102-P of the fuse link 102.

In electromigration mode programming, upon provision of a programming pulse (e.g. programming voltage pulse) to the fuse 100 (e.g. by the programming circuit 104), a current may flow through the fuse link 102 (e.g. indicated in the example of FIG. 2 as the current flow direction 108). The current may preferentially flow through the silicide layer 102-S, e.g. since the resistance of the silicide layer 102-S may be smaller than the resistance of the polysilicon layer 102-P.

As described above, the thickness TS of the silicide layer 102-S may be smaller than the thickness TP of the polysilicon layer 102-P. Accordingly, the preferential flow of the current through the silicide layer 102-S may result in a higher current density in the silicide layer 102-S than in the polysilicon layer 102-P. In other words, the current density in the silicide layer 102-S may be larger than the current density in the polysilicon layer 102-P. The higher current density in the silicide layer 102-S may, at least in part, cause movement of material (e.g. silicide material) from one part of the silicide layer 102-S to another part of the silicide layer 102-S. For instance, in the example shown in FIG. 2, material (e.g. silicide material) may be removed from a part or portion of the silicide layer 102-S proximal the first terminal region 106-1 and transported to a part or portion of the silicide layer 102-S proximal the second terminal region 106-2. In other words, material (e.g. silicide material) of the silicide layer 102-S may migrate from a part or portion of the silicide layer 102-S proximal the first terminal region 106-1 to a part or portion of the silicide layer 102-S proximal the second terminal region 106-2. In another example, material (e.g. silicide material) of the silicide layer 102-S may migrate from a part or portion of the silicide layer 102-S proximal the second terminal region 106-2 to a part or portion of the silicide layer 102-S proximal the first terminal region 106-1. The migration of material (e.g. silicide material) from one part or portion of the silicide layer 102-S to another part or portion of the silicide layer 102-S may be referred to as electromigration.

Electromigration may generate voids in the silicide layer 102-S, e.g. in the part or portion of the silicide layer 102-S from which material (e.g. silicide material) is removed. Consequently, electromigration may increase a resistance (e.g. ohmic or electrical resistance) of the fuse link 102. After void generation in the silicide layer 102-S, the current may continue to flow through the polysilicon layer 102-P of the fuse link 102. Furthermore, the current flowing through the silicide layer 102-S and/or polysilicon layer 102-P of the fuse link 102 may heat up the fuse link 102. In other words, the fuse link 102 may heat up due to self-heating.

As described above, programming the fuse 100 may include, or may consist of, at least one of: changing a state of the fuse 100 from an unprogrammed state to a programmed state, changing a resistance of the fuse 100 from a first resistance value to a second resistance value, and changing a resistance of the fuse 100 from a first ohmic state (e.g. low-ohmic state) to a second ohmic state (e.g. high-ohmic state). Accordingly, in electromigration mode programming, the fuse 100 may be programmed by means of the above-described mechanism.

An unprogrammed fuse 100 may have a resistance (e.g. ohmic or electrical resistance) of less than 1000 ohms, e.g. less than 500 ohms, e.g. less than 200 ohms, e.g. in the range from about 100 ohms to about 500 ohms, e.g. in the range from about 100 ohms to about 200 ohms.

A programmed fuse 100 may have a resistance (e.g. ohmic or electrical resistances) of greater than 2000 ohms, e.g. greater than 5000 ohms, e.g. greater than 10000 ohms, e.g. in the range from about 5000 ohms to about 10 mega ohms, e.g. in the range from about 10000 ohms to about 5 mega ohms.

A respective resistance of an unprogrammed fuse and a respective resistance of a programmed fuse may occur with a respective probability. This may be illustrated by means of cumulative resistance distributions of unprogrammed and programmed fuses.

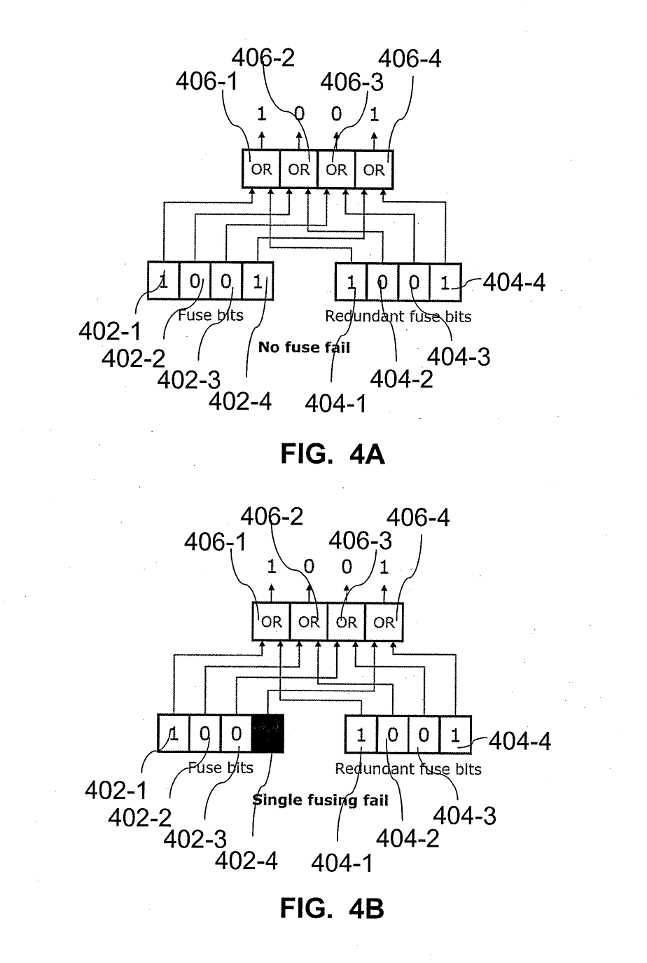

FIG. 3 shows cumulative resistance distributions of unprogrammed and programmed fuses.

In the example shown in FIG. 3, the horizontal axis H1 indicates resistance values (in ohms), a first vertical axis V1 indicates a cumulative probability of a respective resistance value, and a second vertical axis V2 indicates a number of normal standard deviations a respective resistance value is from a mean.

The curve 302 shows the cumulative resistance distribution of an unprogrammed fuse, and the curve 304 shows the cumulative resistance distribution of a programmed fuse.

The curve 302 shows that a resistance of an unprogrammed fuse may be in a range R1 of resistance values. The curve 304 shows that a resistance of a programmed fuse may be in a range R2 of resistance values. As shown in FIG. 3, the range R2 of resistance values may be wider than the range R1 of resistance values. In other words, the resistance of an unprogrammed fuse may be in a tighter range of values than the resistance of a programmed fuse.

As described above, a sensing circuit (e.g. sense amplifier) may distinguish between an unprogrammed fuse and a programmed fuse, e.g. by means of sensing a resistance of a fuse (e.g. relative to a threshold). For example, the sensing circuit (e.g. sense amplifier) may distinguish between an unprogrammed fuse and a programmed fuse by means of a decision level, which is indicated in FIG. 3 as resistance threshold value TH. For example, the sensing circuit (e.g. sense amplifier) may determine that a fuse is programmed if the resistance of the fuse is above the resistance threshold value TH. On the other hand, the sensing circuit (e.g. sense amplifier) may determine that a fuse is unprogrammed if the resistance of the fuse is below the resistance threshold value TH. In the example shown in FIG. 3, the threshold value TH is about 2000 ohms.

An unprogrammed fuse may, for example, be used to indicate the binary digit ‘0’, while a programmed fuse may, for example, be used to indicate the binary digit ‘1’. Conversely, an unprogrammed fuse may, for example, be used to indicate the binary digit ‘1’, while a programmed fuse may, for example, be used to indicate the binary digit ‘0’. Accordingly, a fuse may be used to indicate a value of a bit.

As shown in FIG. 3, the resistance of a programmed fuse may assume a value that may be at a lower range L of the range R2 of resistance values. Resistance values at the lower range L of the range R2 of resistance values may be relatively close to the resistance threshold value TH. For instance, in the example shown in FIG. 3, about 0.1% of the programmed fuses have resistance values of less than or equal to 30000 ohms, which is relatively close to the threshold value TH of about 2000 ohms.

A resistance of a programmed fuse may drift over time. For example, the resistance of a programmed fuse may decrease over time. Illustratively, resistance drift in a programmed fuse may cause the curve 304 to shift to the left. Accordingly, the resistance values at the lower range L of the range R2 of resistance values may drift closer to the resistance threshold value TH and may eventually straddle, or may be below, the resistance threshold value TH. In such an example, a programmed fuse having a resistance in the lower range L of the range R2 of resistance values may be erroneously determined by the sensing circuit (e.g. sense amplifier) as being an unprogrammed fuse. This may result in a programming failure and/or a fuse failure.

In the example shown in FIG. 3, the resistance values at the lower range L of the range R2 of resistance values may be close to, but still above, the resistance threshold value TH. In another example, the resistance values at the lower range L of the range R2 of resistance values may already be below, or may straddle, the resistance threshold value TH, e.g. prior to resistance drift. In such an example, a programmed fuse having a resistance in the lower range L of the range R2 of resistance values may also be erroneously determined by the sensing circuit (e.g. sense amplifier) as being an unprogrammed fuse. This may also result in a programming failure and/or a fuse failure.

A fuse (e.g. e-fuse) may be programmed (e.g. programmed once) at any time during a lifetime of a product. For example, programming a fuse may include programming a fuse during a wafer test of at least one chip that may include the fuse (e.g. in a final wafer test, e.g. during in-house testing). By way of another example, programming a fuse may include programming a fuse that may be assembled on a board. By way of yet another example, programming a fuse may include programming a fuse that may be assembled in a device. By way of an even further example, programming a fuse may include programming a fuse that may be included or integrated in a final product at the end-customer. Accordingly, a programming failure and/or a fuse failure may result in a loss of chip yield during the wafer test stage or may result in failure of the final product at the end-customer, e.g. during operation of the final product.

As described above, a fuse may be used to indicate a value of a bit. A programmed fuse (e.g. which may be used to indicate the binary digit ‘1’) may erroneously be determined to be an unprogrammed fuse (e.g. which may, for example, correspond to the binary digit ‘0’). Accordingly, the value of a bit may be indicated in error.

The use of Error Correction Code (ECC) schemes may be a currently used method for increasing programming yield (which may refer to the number of correctly indicated bits). However, the use of ECC may increase a complexity of a chip and/or a product, e.g. since logic circuitry may be required to correct bits that may be in error. Further, ECC may increase the number of bits required to represent data and/or information. Accordingly, the use of ECC may increase a size of the chip.

Another currently used method for increasing programming yield may include using two or more fuses to indicate a value of one bit.

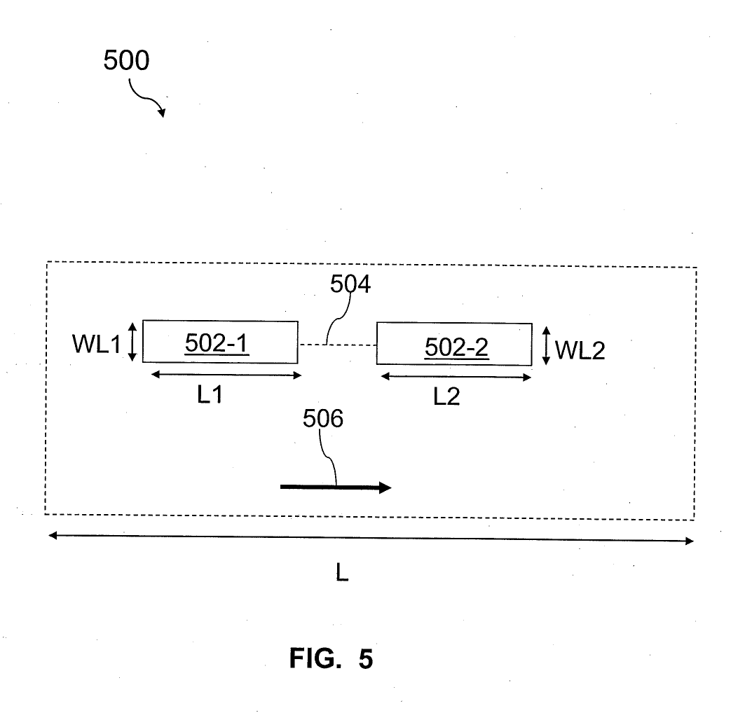

FIG. 4A and FIG. 4B show an example where two fuses are used to indicate a value of one bit.

Only four bits 406-1 to 406-4 are shown as an example. However, the number of bits may be less than four (e.g. one, two, or three) or may be greater than four and may, for example, be five, six, seven, eight, nine, or tens of bits.

In the arrangement shown in FIG. 4A and FIG. 4B, each of the fuses 402-1 to 402-4 and 404-1 to 404-4 may be determined, e.g. by means of a sensing circuit (e.g. sense amplifier), to be a programmed fuse or an unprogrammed fuse. If a fuse is determined to be a programmed fuse, a binary value of ‘1’ may be assigned to the fuse. If a fuse is determined to be an unprogrammed fuse, a binary value of ‘0’ may be assigned to the fuse. The binary values assigned to the fuses 402-1 to 402-4 and 404-1 to 404-4 may subsequently be combined in a logical OR operation to indicate the value of a respective bit.

For example, the binary values assigned to fuses 402-1 and 404-1 may be combined in a logical OR operation to indicate a binary value of bit 406-1; the binary values assigned to fuses 402-2 and 404-2 may be combined in a logical OR operation to indicate a binary value of bit 406-2; the binary values assigned to fuses 402-3 and 404-3 may be combined in a logical OR operation to indicate a binary value of bit 406-3; and the binary values assigned to fuses 402-4 and 404-4 may be combined in a logical OR operation to indicate a binary value of bit 406-4.

In the arrangement shown in FIG. 4A, each fuse may be correctly determined as a programmed fuse (e.g. corresponding to binary digit ‘1’) or an unprogrammed fuse (e.g. corresponding to binary digit ‘0’). Accordingly, the binary value assigned to each fuse may be correctly determined as binary digit ‘1’ or binary digit ‘0’. Consequently, the bits 406-1 to 406-4 may be correctly indicated.

In the arrangement shown in FIG. 4B, the fuse 402-4 may be erroneously determined as an unprogrammed fuse (e.g. corresponding to binary digit ‘0’), while the fuse 404-4 may be correctly determined as a programmed fuse (e.g. corresponding to binary digit ‘1’). However, the bit 406-4 may still be correctly indicated (e.g. as binary digit ‘1’), due to the binary values assigned to the two fuses 402-4, 404-4 being combined in a logical OR operation to indicate the value of the bit 406-4. Accordingly, the programming yield may be increased.

As shown in FIG. 3, a probability of the resistance of a programmed fuse being in the lower range L of the range R2 of resistance values may be less than or equal to about 1%, e.g. less than or equal to about 0.1%, e.g. less than or equal to about 100 ppm, e.g. less than or equal to about 10 ppm. Accordingly, a fuse failure rate may be in the range of a few ppm.

A resistance of a fuse may be independent (e.g. statistically independent) from a resistance of another fuse. Consequently, a resistance of a first programmed fuse may be independent (e.g. statistically independent) from a resistance of a second programmed fuse, which may, for example, be a neighbour of the first programmed fuse. As used herein, a neighboring fuse may include, or may be, a fuse that may be adjacent to or proximate another fuse.

Since a resistance of a fuse may be independent (e.g. statistically independent) from a resistance of another fuse, a relationship between a fuse failure rate (FF) and a chip failure rate (CF) for a chip including N1 programmed bits may be approximately written as:

FF^{N2}=CF/N1,

where N2 is the number of fuses used to indicate a value of a bit.

Illustratively, in the example shown in FIG. 4, the number of programmed bits N1 included in the chip may be 4 (i.e. N1=4), while the number of fuses used to indicate a value of a bit may be 2 (i.e. N2=2).

As described above, a fuse failure rate may be in the range of a few ppm. However, the number of programmed bits N1 included in a chip, as well as the number of fuses N2 used to indicate a value of a bit may need to be considered in order to determine a maximum allowable fuse failure rate (FF) given a maximum allowable chip failure rate (CF).

By way of an example, assuming a maximum allowable chip failure rate (CF) of 1 ppm (i.e. CF=1 ppm) in a chip including 1000 programmed bits (i.e. N1=1000), the maximum allowable fuse failure rate (FF) would be 1 ppm/1000=0.001 ppm if only one fuse is used to indicate a value of a bit (i.e. N2=1). This required fuse failure rate (FF) may hardly be achievable. However, if two fuses are used to indicate a value of a bit (i.e. N2=2), the maximum allowable fuse failure rate (FF) is √(1 ppm/1000)≈32 ppm. This may be achievable. Accordingly, using more than one fuse to indicate a value of a bit may allow for a more relaxed fuse failure rate (FF), while maintaining the maximum allowable chip failure rate (CF).

While provision of two or more fuses to indicate the value of the bit may relax the maximum allowable fuse failure rate (FF) and may be easy to implement, such an approach may lead to increased chip area and/or increased programming time since the two or more fuses may need to be programmed in series (namely, one after the other). In other words, the two or more fuses may not be programmed simultaneously, e.g. by means of the same programming pulse. In other words, different programming pulses may be needed to program the two or more fuses used to indicate a value of a bit. Furthermore, each of the two or more fuses used to indicate a value of a bit may be coupled (e.g. electrically coupled) to respective sensing circuits, level shifters and/or signal drivers. Accordingly, the increased chip area resulting from the use of two or more fuses to indicate a value of a bit may be exacerbated.

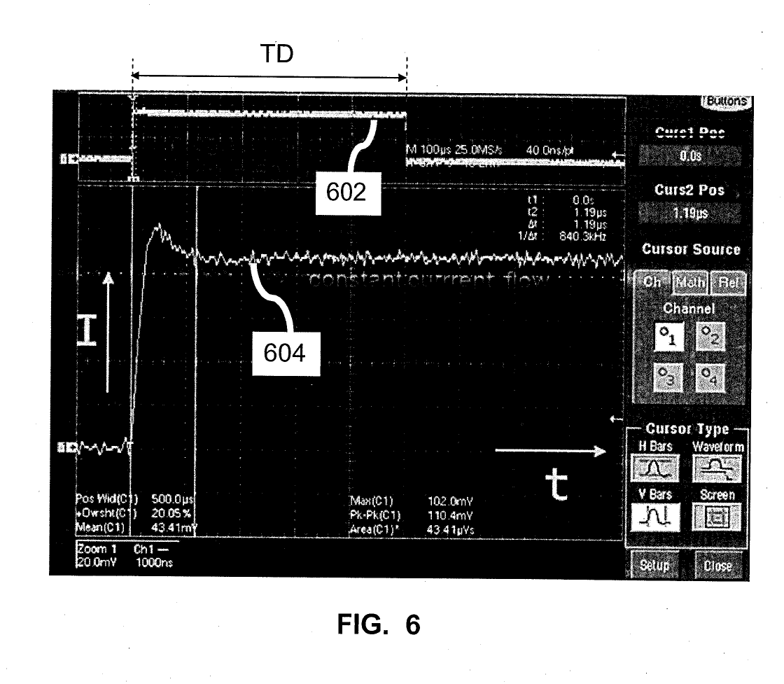

In view of the above-mentioned features of the conventional fuse 100 and the conventional methods for increasing programming yield, a fuse 500 shown in FIG. 5 is provided.

FIG. 5 shows a schematic plan view of a fuse 500.

The fuse 500 may include a first fuse link 502-1 and a second fuse link 502-2, which may be coupled (e.g. electrically coupled) in series to the first fuse link 502-1. The series coupling (e.g. series electrical coupling) between the first fuse link 502-1 and the second fuse link 502-2 is indicated in FIG. 5 as series coupling 504.

FIG. 5 shows, as an example, two fuse links 501-1 and 502-2 that may be coupled in series. However, the number of fuse links that may be coupled in series with each other may be more than two, and may e.g. be three, four, five, etc. In other words, the fuse 500 may include at least one additional fuse link that may be coupled in series to the second fuse link 502-2.

Since the second fuse link 502-2 may be coupled in series to the first fuse link 502-1, a current flowing through the first fuse link 502-1 may be at least substantially equal to (e.g. identical to) a current flowing through the second fuse link 502-2. Accordingly, a programming current flowing through the first fuse link 502-1 may be at least substantially equal to (e.g. identical to) a programming current flowing through the second fuse link 502-2.

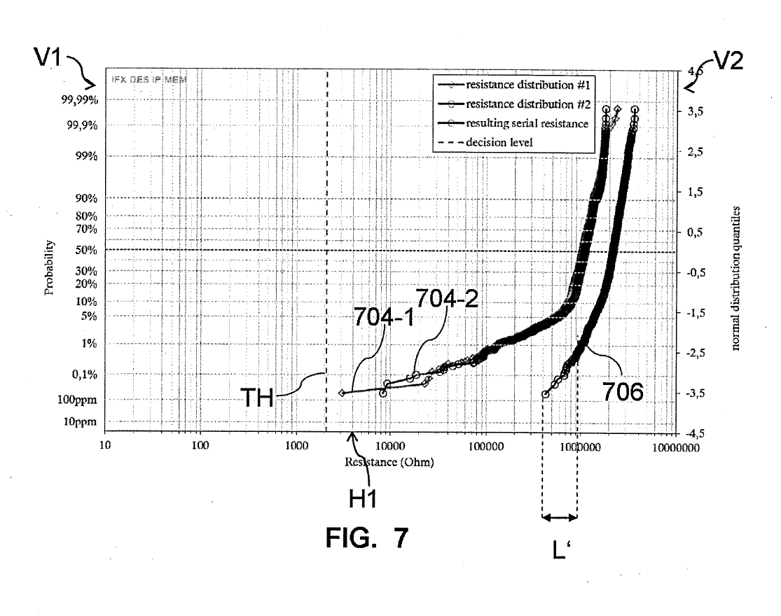

FIG. 6 shows a programming pulse 602 and a programming current 604 as a function of time.

The programming current 604 may, for example, be a current flowing through the first fuse link 502-1, e.g. as a result of providing the programming pulse 602 to the fuse 500.

The programming pulse 602 may, for example, be provided (e.g. to the fuse 500) by a fuse operating circuit, which may be coupled to the fuse 500. A time duration TD of the programming pulse 602 may be in the range from about 10 μs to about 600 μs, e.g. in the range from about 20 μs to about 500 μs, e.g. in the range from about 30 μs to about 400 μs, e.g. in the range from about 50 μs to about 200 μs, e.g. in the range from about 100 μs to about 150 μs, although other time durations may be possible as well.

As shown in FIG. 6, the programming current 604 may flow over the entire time duration TD of the programming pulse 602, e.g. through the first fuse link 502-1. Furthermore, as shown in FIG. 6, the programming current 604 may be at least substantially constant (e.g. have a constant current magnitude) over the entire time duration TD of the programming pulse 602. Similarly, as shown in FIG. 6, the programming current 604 may not be interrupted over the entire time duration TD of the programming pulse 602. Consequently, the programming current 604, which may flow through the first fuse link 502-1, may also flow through the second fuse link 502-2, e.g. since the first and second fuse links 502-1, 502-2 may be coupled in series.

As a result, the first and second fuse links 502-1, 502-2 may be programmed using the same programming pulse 602. In other words, the first and second fuse links 502-1, 502-2 may be programmed simultaneously, e.g. using the same programming pulse 602. In still other words, the programming current 604 may flow through both the first fuse link 502-1 and the second fuse link 502-2, and as a result of the programming current 604 flowing through both of the fuse links, both fuse links may be programmed in a single programming time interval. This is in contrast to the conventional method of providing two or more fuses to indicate the value of a bit, where the two or more fuses may need to be programmed using two or more corresponding programming pulses, for example two or more programming pulses applied in series (namely, one after the other). Accordingly, a time taken to program a chip including the single fuse 500 having the plurality of series-coupled fuse links 502-1, 502-2 may be shorter than a time taken to program a chip including two or more individual fuses (each having a single fuse link) that may be used to indicate the value of a bit (e.g. as described above in relation to FIG. 4A and FIG. 4B).

Since the second fuse link 502-2 may be coupled in series to the first fuse link 502-1, the overall resistance R of the fuse 500 that may, for example, be achieved with the programming pulse 602 may be calculated as:

R=R1+R2,

where R1 may be the resistance of the first fuse link 502-1 after programming (e.g. with the programming pulse 602) and R2 may be the resistance of the second fuse link 502-2 after programming (e.g. with the programming pulse 602).

As described above, a resistance of a (programmed) fuse may be independent (e.g. statistically independent) from a resistance of another (programmed) fuse. Consequently, a resistance of a first programmed fuse may be independent (e.g. statistically independent) from a resistance of a second programmed fuse, which may, for example, be a neighbour of the first programmed fuse. Therefore, the resistances R1 and R2 of the first and second fuse links 502-1, 502-2 may be independent (e.g. statistically independent) from each other. Accordingly, even if the resistance R1 of the first fuse link 502-1 may be low (e.g. with a low probability, e.g. less than or equal to about 1%), the resistance R2 of the second fuse link 502-2 may be high (e.g. with a high probability, e.g. greater than or equal to about 50%).

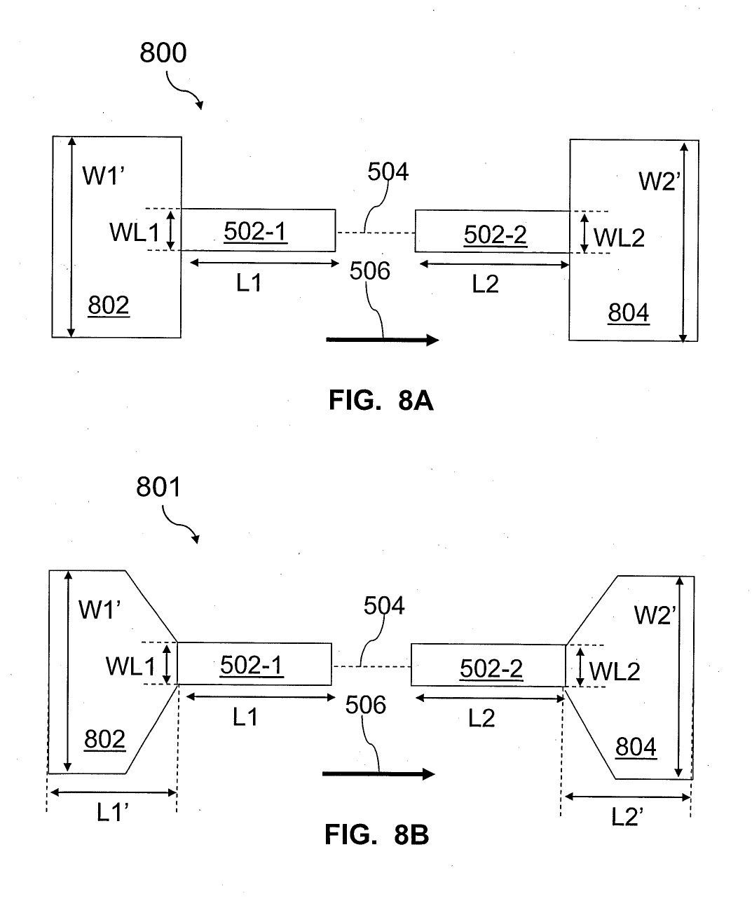

FIG. 7 shows cumulative resistance distributions of each of fuse links 502-1, 502-2 in the programmed states as well as a cumulative resistance distribution of a series coupling of the fuse links 502-1 and 502-2 in the programmed state.

In the example shown in FIG. 7, the horizontal axis indicates resistance values (in ohms), a first vertical axis V1 indicates a cumulative probability of a respective resistance value, and a second vertical axis V2 indicates a number of normal standard deviations a respective resistance value is from a mean.

The curves 704-1 and 704-2 show the cumulative resistance distribution of programmed first and second fuse links 502-1 and 502-2, respectively. In other words, the curve 704-1 shows the cumulative distribution of the resistance R1 and the curve 704-2 shows the cumulative distribution of the resistance R2.

The curve 706 shows the cumulative resistance distribution of the series coupling of programmed first and second fuse links 502-1 and 502-2. Accordingly, the curve 706 may show the cumulative resistance distribution of the fuse 500 in the programmed state, including the programmed first and second fuse links 502-1 and 502-2 coupled in series. In other words, the curve 706 shows the cumulative distribution of the overall resistance R of the programmed fuse 500, where R=R1+R2 as described above.

As shown in FIG. 7, the curve 706 may be farther from the resistance threshold value TH than each of the curves 704-1 and 704-2. As described above, a resistance of a programmed fuse may drift over time. For example, the resistance of the programmed fuse 500 may decrease over time. Illustratively, resistance drift in the programmed fuse 500 may cause the curve 706 to shift to the left. However, even if this were so, the resistance values at a lower range L′ of the curve 706 may still be large and thus may be far enough from the resistance threshold value TH such that the programmed fuse 500 may still be correctly determined (e.g. by a sensing circuit, e.g. a sense amplifier) as being a programmed fuse. Accordingly, the fuse 500 including a series coupling of the first and second fuse links 502-1, 502-2 may decrease a fuse failure rate and/or programming failure rate and may, consequently, improve a lifetime and/or a reliability of a chip that may include the fuse 500.

Referring to FIG. 5, the fuse 500 may be configured as an electrically programmable fuse (electrical fuse, e-fuse). In accordance with various embodiments, the fuse 500 may be configured as at least one of a polysilicon fuse, a metal fuse, and a cavity fuse, although other configurations of the fuse 500 may be possible as well.

The first and second fuse links 502-1, 502-2 may have at least substantially identical dimensions. For example, a length L1 of the first fuse link 502-1 may be at least substantially identical to a length L2 of the second fuse link 502-2. By way of another example, a width WL1 of the first fuse link 502-1 may be at least substantially identical to a width W2 of the second fuse link 502-2. By way of yet another example, a thickness of the first fuse link 502-1 (e.g. measured in a direction perpendicular to L1 and W1) may be at least substantially identical to a thickness of the second fuse link 502-2. Alternatively, the first and second fuse links 502-1, 502-2 may differ in at least one, e.g. two, e.g. all, dimensions.

At least one of the first fuse link 502-1 and the second fuse link 502-2 may include, or may consist of, polysilicon. The polysilicon may include, or may consist of, doped polysilicon (e.g. n-doped polysilicon and/or p-doped polysilicon) and/or undoped polysilicon.

For example, the first and second fuse links 502-1, 502-2 may include, or may consist of, polysilicon, and the polysilicon of one of the first and second fuse links 502-1, 502-2 may include, or may consist of, doped polysilicon (e.g. n-doped or p-doped polysilicon) and the polysilicon of the other one of the first and second fuse links 502-1, 502-2 may include, or may consist of, undoped polysilicon. In other words, the first fuse link 502-1 may include, or may consist of, doped polysilicon (e.g. n-doped and/or p-doped polysilicon), and the second fuse link 502-2 may include, or may consist of, undoped polysilicon, or vice versa.

By way of another example, the first and second fuse links 502-1, 502-2 may include, or may consist of, polysilicon, and the polysilicon of one of the first and second fuse links 502-1, 502-2 may include, or may consist of, n-doped polysilicon and the polysilicon of the other one of the first and second fuse links 502-1, 502-2 may include, or may consist of, p-doped polysilicon. In other words, the first fuse link 502-1 may include, or may consist of, n-doped polysilicon, and the second fuse link 502-2 may include, or may consist of, p-doped polysilicon, or vice versa.

At least one of the first and second fuse links 502-1, 502-2 may include, or may consist of, a polysilicon layer and a silicide layer at a surface of the polysilicon layer. For example, the silicide layer may be disposed at an upper surface of the polysilicon layer. Alternatively or additionally, the silicide layer may be disposed at a lower surface and/or at one or more sidewalls of the polysilicon layer. The polysilicon layer may contain, or may consist of, n-doped, p-doped or undoped polysilicon. The silicide layer may contain, or may consist of, a silicide. The silicide may include, or may be, at least one of tungsten silicide, molybdenum silicide, titanium silicide, nickel silicide, and cobalt silicide, although other silicides may be possible as well.

At least one of the first and second fuse links 502-1, 502-2 may include, or may consist of, a metal or metal alloy. For example, at least one of the first and second fuse links 502-1, 502-2 may include, or may consist of, at least one of copper, nickel, cobalt, titanium, tungsten, aluminum and/or an alloy of at least one of the aforementioned metals, although other metals or metal alloys may be possible as well.

At least one of the first and second fuse links 502-1, 502-2 may include, or may consist of, a metal or metal alloy layer and a liner at a surface of the metal or metal alloy layer. For example, the liner may be disposed at an upper surface of the metal or metal alloy layer. Alternatively or additionally, the liner may be disposed at a lower surface and/or at one or more sidewalls of the metal or metal alloy layer. The metal or metal alloy layer may contain, or may consist of, at least one of copper, nickel, cobalt, titanium, tungsten, aluminum and/or an alloy of at least one of the aforementioned metals, although other metals or metal alloys may be possible as well. The liner may contain, or may consist of, a metal or metal alloy. The metal may include at least one metal selected from a group of metals, the group consisting of: copper, titanium, aluminium, chromium and gold, or an alloy containing at least one of the aforementioned metals, although other metals or metal alloys may be possible as well.

The fuse 500 may include a plurality of levels. The plurality of levels may include at least one metallization level and at least one polysilicon level. A polysilicon level may, for example, include or refer to a level in a semiconductor device (e.g. chip), in which a polysilicon layer (e.g. polysilicon gate of a transistor, e.g. MOS transistor) is located. A metallization level may, for example, include or refer to a level in a semiconductor device (e.g. chip), in which one or more interconnects are located, e.g. Metal-1, Metal-2, . . . , Metal-N level. In relation to FIG. 5, the plurality of levels may be arranged in a direction perpendicular to the drawing plane shown in FIG. 5. The at least one metallization level of the fuse 500 may be arranged above and/or below the at least one polysilicon level of the fuse 500. Similarly, the at least one polysilicon level of the fuse 500 may be arranged above and/or below the at least one metallization level of the fuse 500. The plurality of levels may, for example, be coupled (e.g. electrically coupled) by means of at least one via (e.g. at least one through-via).

The first and second fuse links 502-1, 502-2 may be disposed in the same level of the fuse 500.

For example, the first and second fuse links 502-1, 502-2 may include or may be disposed in a polysilicon layer of the fuse 500 (e.g. in a polysilicon level of a semiconductor device (e.g. chip) including the fuse 500), e.g. in the example where the first and second fuse links 502-1, 502-2 may include, or may consist of, polysilicon and/or in the example where the first and second fuse links 502-1, 502-2 may include, or may consist of, a polysilicon layer and a silicide layer at a surface of the polysilicon layer.

By way of another example, the first and second fuse links 502-1, 502-2 may be disposed in a metallization layer of the fuse 500 (e.g. in a metallization level (e.g. Metal-1, Metal-2, . . . , Metal-N) of a semiconductor device (e.g. chip) including the fuse 500), e.g. in the example where the first and second fuse links 502-1, 502-2 may include, or may consist of, a metal or metal alloy and/or in the example where the first and second fuse links 502-1, 502-2 may include, or may consist of, a metal or metal alloy layer and a liner at a surface of the metal or metal alloy layer.

The first and second fuse links 502-1, 502-2 may be configured to have a lateral current flow, which may be indicated in FIG. 5 as a current flow direction 506. In other words, a current flow through the first and second fuse links 502-1, 502-2 may not flow in a direction perpendicular to the drawing plane shown in FIG. 5, but may, instead, flow along at least a part or portion of a lateral extent L of the fuse 500. In various embodiments, the current flow direction 506 may be parallel or at least substantially parallel to the length direction of the first fuse link 502-1 and/or the length direction of the second fuse link 502-2.

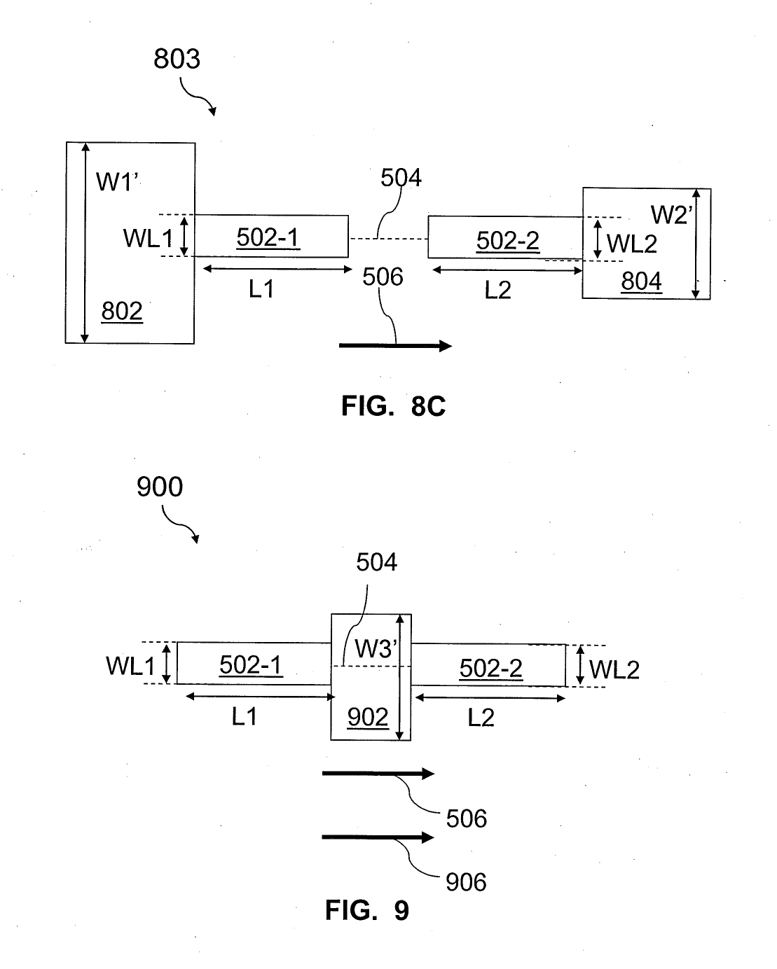

FIG. 8A to FIG. 8C show schematic plan views of fuses 800, 801, 803, each including a first terminal region 802 and a second terminal region 804.

Reference signs in FIG. 8A to FIG. 8C that are the same as in FIG. 5 denote the same or similar elements as in FIG. 5. Thus, those elements will not be described in detail again here; reference is made to the description above.

As shown in FIG. 8A to FIG. 8C, the first and second fuse links 502-1, 502-2 may be coupled between the first and second terminal regions 802, 804. The first terminal region 802 may abut the first fuse link 502-1, and the second terminal region 804 may abut the second fuse link 502-2.

The first and second terminal regions 802, 804 may have at least substantially identical dimensions and/or shapes (e.g. as shown in FIG. 8A and FIG. 8B). In another example, the first and second terminal regions 802, 804 may have different dimensions and/or shapes (e.g. as shown in FIG. 8C).

A cross-sectional area of the first terminal region 802 may be larger than a cross-sectional area of the first fuse link 502-1, and a cross-sectional area of the second terminal region 804 may be larger than a cross-sectional area of the second fuse link 502-2. As used herein, a cross-sectional area may refer to an area of a transverse cross-section, e.g. a cross-section that may be at least substantially perpendicular to the current flow direction 506 in at least one of the fuse links 502-1, 502-2.

As shown in FIG. 8A, a width W1′ of the first terminal region 802 may be wider than a width WL1 of the first fuse link 502-1, and a width W2′ of the second terminal region 804 may be wider than a width WL2 of the second fuse link 502-2. The width W1′ the first terminal region 802 may be the same or substantially the same as the width W2′ of the second terminal region 804, as shown in FIG. 8A, or the widths W1′ and W2′ may be different. For example, the width W2′ may be smaller than the width W1′, as shown in FIG. 8C.

As shown in FIG. 8B, the width of the first and second terminal regions 802, 804 may vary along a lateral extent of the first and second terminal regions 802, 804, respectively. For example, the width W1′ of the first terminal region 802 may vary along at least a part or a portion of its lateral extent L1′. For example, the width W1′ may decrease from a part or portion of the first terminal region 502-1 distal from the first fuse link 502-1 to a part or portion of the first terminal region 502-1 proximal to the first fuse link 502-1. In other words, as shown in FIG. 8B, the first terminal region 802 may, for example, be tapered, e.g. such that the part or portion of the first terminal region 802 having the narrowest width may be located closest to the first fuse link 502-2 and the part or portion of the first terminal region 802 having the widest width may be located farthest from the first fuse link 502-2. A similar arrangement may be observed for the second terminal region 804 and the second fuse link 502-2.

The first and second terminal regions 802, 804 may be made of the same material as the first and second fuse links 502-1, 502-2. For example, the first and second terminal regions 802, 804 may include, or may consist of, at least one of polysilicon, silicide, metal, and a metal alloy. The first and second terminal regions 802, 804 may be disposed in the same level, e.g. same polysilicon level, as the first and second fuse links 502-1, 502-2.

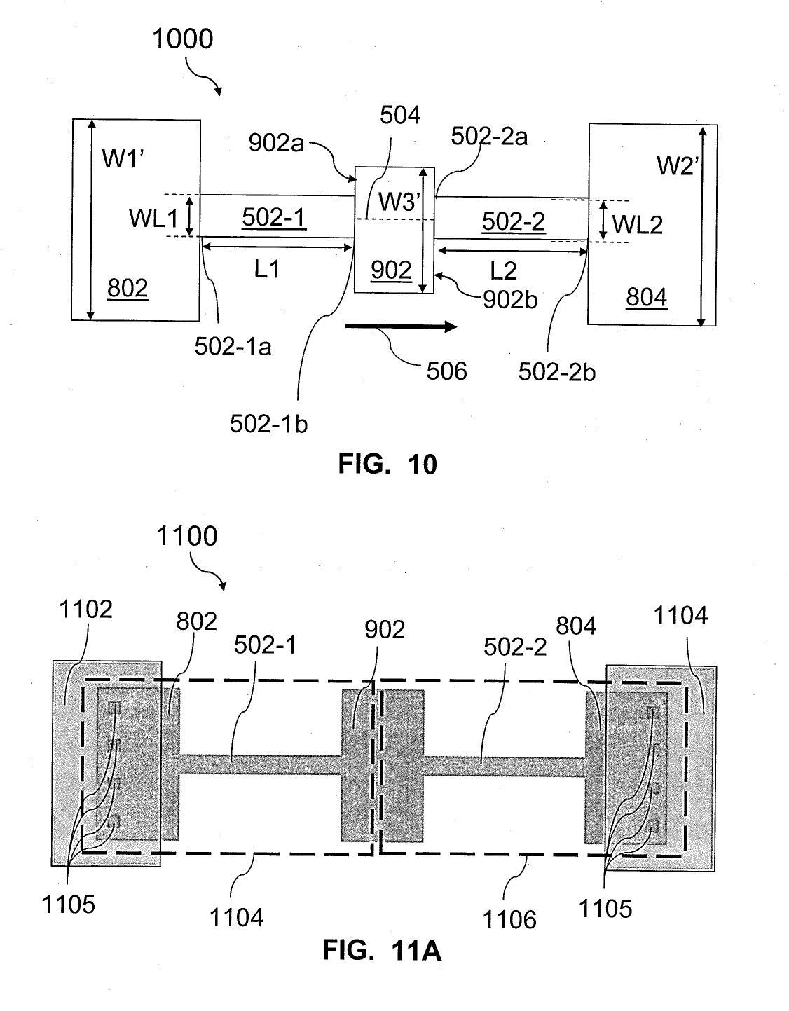

FIG. 9 shows a schematic plan view of a fuse 900 including at least one connection element 902 coupled between the first and second fuse links 502-1, 502-2.

Reference signs in FIG. 9 that are the same as in FIG. 5 denote the same or similar elements as in FIG. 5. Thus, those elements will not be described in detail again here; reference is made to the description above.

The at least one connection element 902 may, for example, be an intermediary structure that may provide the series coupling 504 between the first and second fuse links 502-1, 502-2. The at least one connection element 902 may abut the first fuse link 502-1 and/or the second fuse link 502-2.

The at least one connection element 902 may include, may be, or may be configured as, a non-fusable connection element. For example, during a programming of the fuse 900, the first and/or second fuse links 502-1, 502-2 may be selectively disconnected, blown, or cut (e.g. in rupture mode programming), or material from the first and/or second fuse links 502-1, 502-2 may be removed (e.g. in electromigration mode programming). However, the at least one connection element 902 (e.g. non-fusable connection element) may remain intact during and after the programming of the fuse 900. In other words, an integrity of the at least one connection element 902 (e.g. non-fusable connection element) may be preserved during and after the programming of the fuse 900.

The at least one connection element (e.g. non-fusable connection element) may be configured to have a lateral current flow, which may be indicated in FIG. 9 as current flow direction 906. In other words, a current flow through the at least one connection element (e.g. non-fusable connection element) may not flow in a direction perpendicular to the drawing plane shown in FIG. 9, but may, instead, flow at least substantially parallel to the current flow direction 506 through at least one of the first and second fuse links 502-1, 502-2.

The at least one connection element 902 (e.g. non-fusable connection element) may be disposed in a polysilicon level of the fuse 900. In such an example, the at least one connection element 902 may include, or may consist of, polysilicon. For example, the at least one connection element 902 may include, or may consist of, a polysilicon layer and a silicide layer disposed at a surface of the polysilicon layer. For example, the silicide layer may be disposed at an upper surface of the polysilicon layer. Alternatively or additionally, the silicide layer may be disposed at a lower surface or at one or more sidewalls of the polysilicon layer. The polysilicon layer may contain, or may consist of, n-doped, p-doped or undoped polysilicon. The silicide layer may contain, or may consist of, a silicide. The silicide may include, or may be, at least one of tungsten silicide, molybdenum silicide, titanium silicide, nickel silicide, and cobalt silicide, although other silicides may be possible as well.

The at least one connection element 902 (e.g. non-fusable connection element) may be disposed in a metallization level of the fuse 900. In such an example, the at least one connection element 902 may include, or may consist of, a metal or metal alloy. For example, the at least one connection element 902 may include, or may consist of, at least one of copper, nickel, cobalt, titanium, tungsten, aluminum and/or an alloy of at least one of the aforementioned metals, although other metals or metal alloys may be possible as well.

The at least one connection element 902 (e.g. non-fusable connection element) may be disposed in the same level as the first and second fuse links 502-1, 502-2. In another example, the at least one connection element 902 may be disposed in a different level than the first and second fuse links 502-1, 502-2.

The at least one connection element 902 (e.g. non-fusable connection element) may be disposed in a metallization level of the fuse 900, which may be at least one of above and below the first and second fuse links 502-1, 502-2. In such an example, the first and second fuse links 502-1, 502-2 may themselves be disposed in a polysilicon level of the fuse 900 or in a different metallization level of the fuse 900.

The at least one connection element 902 (e.g. non-fusable connection element) may have a non-minimal feature size. The term “non-minimal feature size” may include or may refer to, e.g., a feature size (e.g., length, width, and/or height) that is larger than a minimal feature size (e.g., minimal length, minimal width, and/or minimal height) achievable in a given process technology or technology node. For example, the at least one connection element 902 may have a width that is wider than a minimal width achievable in a given process technology or technology node.

A cross-sectional area of the at least one connection element 902 (e.g. non-fusable connection element) may be larger than a cross-sectional area of the first fuse link 502-1 and a cross-sectional area of the second fuse link 502-2.

As shown in FIG. 9, a width W3′ of the at least one connection element 902 (e.g. non-fusable connection element) may be wider than the width WL1 of the first fuse link 502-1 and wider than the width WL2 of the second fuse link 502-2.

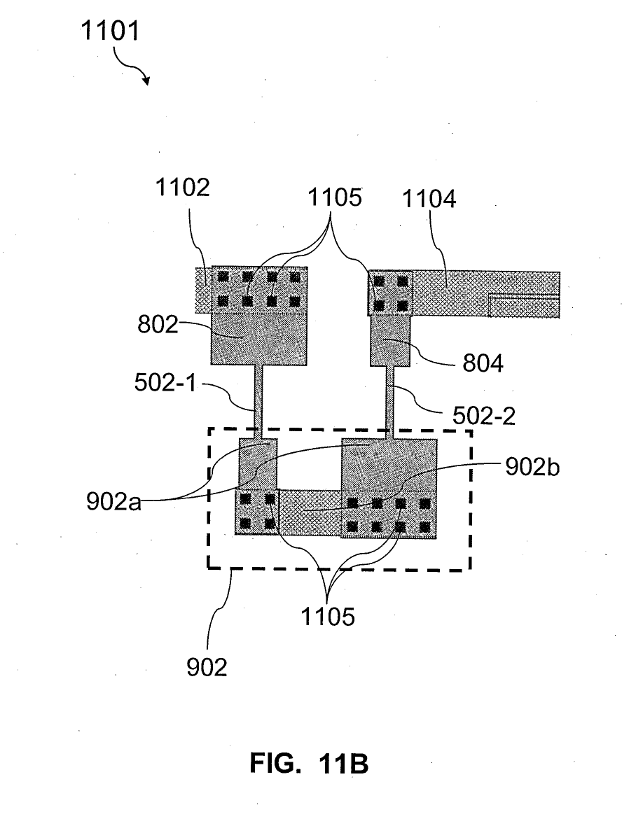

FIG. 10 shows a schematic plan view of a fuse 1000 including a first terminal region 802, a second terminal region 804, and at least one connection element 902.

Reference signs in FIG. 10 that are the same as in FIG. 9, FIG. 8A to FIG. 8C, and FIG. 5 denote the same or similar elements as in FIG. 9, FIG. 8A to FIG. 8C, and FIG. 5. Thus, those elements will not be described in detail again here; reference is made to the description above.

As shown in FIG. 10, the first fuse link 502-1 may be coupled between the first terminal region 802 and the at least one connection element 902 (e.g. non-fusable connection element). As shown in FIG. 10, the second fuse link 502-2 may be coupled between the at least one connection element 902 (e.g. non-fusable connection element) and the second terminal region 804. In other words, the first fuse link 502-1, the second fuse link 502-2, and the at least one connection element (e.g. non-fusable connection element) may be coupled between the first and second terminal regions 802, 804.

As shown in FIG. 10, a first end 502-1a of the first fuse link 502-1 may abut the first terminal region 802, and a second end 502-1b of the first fuse link 502-1 may abut a first side 902a of the at least one connection element 902. Similarly, a first end 502-2a of the second fuse link 502-2 may abut a second side 902b of the at least one connection element 902, and a second end 502-2b of the second fuse link 502-2 may abut the second terminal region 804.

The first and second terminal regions 802, 804 and the at least one connection element 902 (e.g. non-fusable connection element) may be made of the same materials as the first and second fuse links, which are described above.

As shown in FIG. 10, a width W1′ of the first terminal region 802, a width W2′ of the second terminal region 804, and a width W3′ of the at least one connection element 902 (e.g. non-fusable connection element) may be wider than the width WL1 of the first fuse link 502-1 and the width WL2 of the second fuse link 502-2.

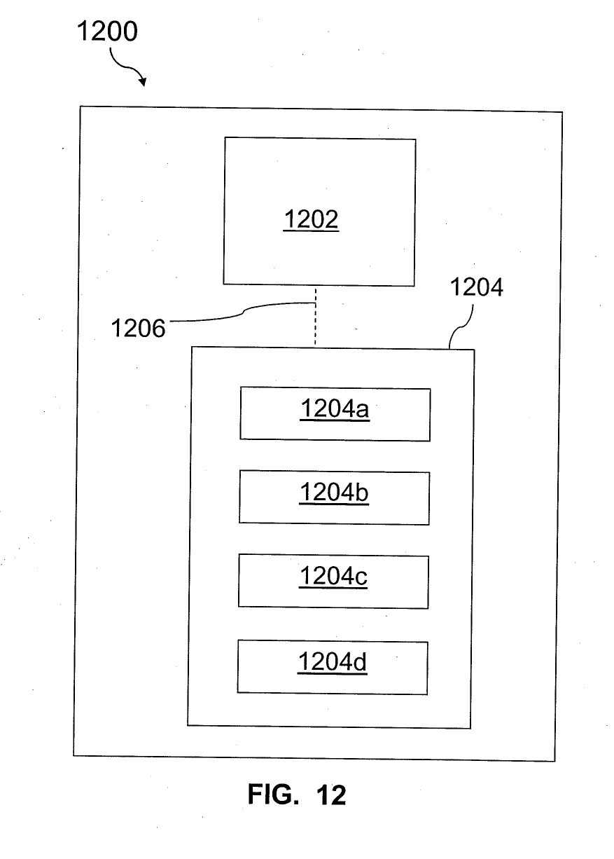

FIG. 11A shows a schematic plan view of a fuse 1100 according to an embodiment.

In the example shown in FIG. 11A, the first and second fuse links 502-1, 502-2, as well as the at least one connection element 902 may be disposed in a polysilicon layer of the fuse 1100, e.g. in a polysilicon level of a semiconductor device (e.g. chip). In other words, FIG. 11A may show a series coupling of the first and second fuse links 502-1, 502-2 that may be connected (e.g. electrically connected) via the polysilicon layer (e.g. by means of the at least one connection element 902 disposed in the polysilicon layer of the fuse 1100). In the example shown in FIG. 11A, the first and second terminal regions 802, 804 may be disposed in the polysilicon layer of the fuse 1100 as well.

The fuse 1100 shown in FIG. 11A may include a first terminal contact 1102 and a second terminal contact 1104. The first and second terminal contacts 1102, 1104 may be disposed in a metallization level of the semiconductor device (e.g. chip), which may be located above and/or below the polysilicon level at which the first and second fuse links 502-1 may be disposed. The first terminal contact 1102 may be coupled (e.g. electrically coupled) to the first terminal region 802, and the second terminal contact 1104 may be coupled (e.g. electrically coupled) to the second terminal region 804. The first and second terminal contacts 1102, 1104 may be coupled (e.g. electrically coupled) to the first and second terminal regions 802, 804, respectively, e.g. by means of one or more vias 1105. The first and second terminal contacts 1102 and 1104 may be coupled to each other, e.g. as a consequence of the coupling (e.g. series coupling) of the first terminal region 802, the first fuse link 502-1, the at least one connection element 902, the second fuse link 502-2, and the second terminal region 804.

As described above, the first and second fuse links 502-1, 502-2 may include, or may consist of, polysilicon, which may have different doping. For instance, in the example shown in FIG. 11A, the first terminal region 802, the first fuse link 502-1, and a part or a portion of the at least one connection element 902 (indicated by box 1104) may include, or may consist of, n-doped polysilicon and the remaining part or portion of the at least one connection element 902, the second fuse link 502-2, and the second terminal region 804 (indicated by box 1106) may include, or may consist of, p-doped polysilicon. It is noted that other combinations of n-doped, p-doped or undoped polysilicon may be possible as well. For example, structures included in the box 1106 may, instead, include, or may consist of, undoped or n-doped polysilicon. By way of another example, the structures included in the box 1104 may, instead, include, or may consist of undoped or p-doped polysilicon.

Different process dependencies may be addressed leading to a more robust fuse 1100. For example, for one process deviation, a p-doped first and/or second fuse link 502-1, 502-2 may program better while for another process deviation, an n-doped first and/or second fuse link 502-1, 502-2 may program better. Hence, the first and second fuse links 502-1, 502-2 having different dopings may provide improved robustness for various process deviations.

FIG. 11B shows a schematic plan view of a fuse 1101 according to another embodiment.

Reference signs in FIG. 11B that are the same as in FIG. 11A denote the same or similar elements as in FIG. 11A. Thus, those elements will not be described in detail again here; reference is made to the description above.

In the example shown in FIG. 11B, the first and second fuse links 502-1, 502-2 may be disposed in a polysilicon layer of the fuse 1101, e.g. in a polysilicon level of a semiconductor device (e.g. chip). The at least one connection element 902 may include a first part or portion 902a that may be disposed in the polysilicon layer of the fuse 1101 and a second part or portion 902b that may be disposed in a metallization level of the fuse 1101, which may be disposed above and/or below the polysilicon level of the fuse 1101. The first part or portion 902a of the at least one connection element 902 may be coupled (e.g. electrically coupled) to the second part or portion 902b of the at least one connection element 902 by means of the at least one via 1105. In other words, FIG. 11B may show a series coupling of the first and second fuse links 502-1, 502-2 that may be connected (e.g. electrically connected) via a metallization layer (e.g. by means of the second part or portion 902b of at least one connection element 902 disposed in a metallization layer of the fuse 1101). In the example shown in FIG. 11B, the first and second terminal regions 802, 804 may be disposed in the polysilicon layer of the fuse 1101, and the first and second terminal contacts 1102, 1104 may be disposed in a metallization level of the fuse 1101.

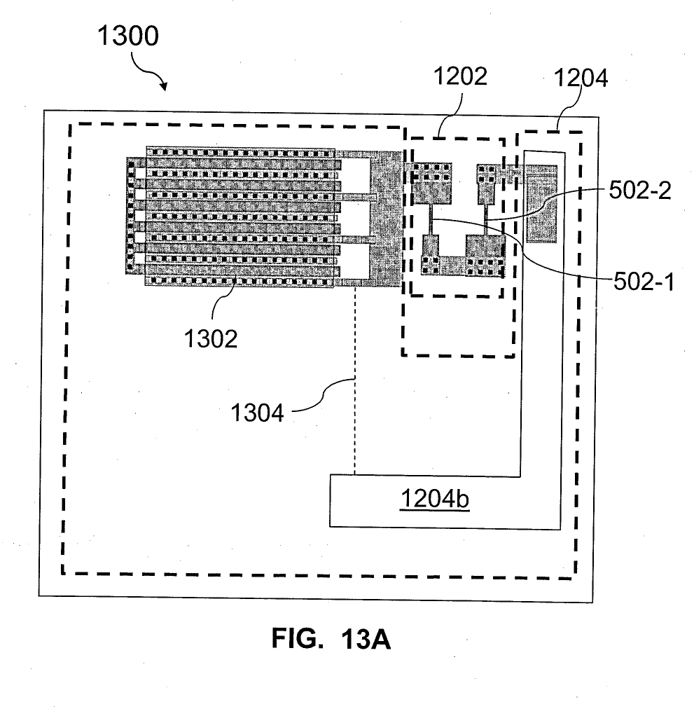

FIG. 12 shows a schematic plan view of a fuse element 1200.

The fuse element 1200 may include a fuse 1202 and a fuse operating circuit 1204 coupled to the fuse 1202. The coupling between the fuse 1202 and the fuse operating circuit 1204 is indicated as coupling 1206.

The fuse 1202 may, for example, include, or may be, at least one of the fuse 500 shown in FIG. 5, the fuses 800, 801, 803 shown in FIG. 8A to FIG. 8C, the fuse 900 shown in FIG. 9, the fuse 1000 shown in FIG. 10, and the fuses 1100, 1101 shown in FIG. 11A and FIG. 11B. Accordingly, the features described above in respect of each of the fuses 500, 800, 801, 803, 900, 1000, 1100, 1101 may be analogously applicable to the fuse 1202 shown in FIG. 12.

The fuse operating circuit 1204 may include, or may be, at least one of: a programming circuit 1204a, a sensing circuit 1204b, a level shifting circuit 1204c, and a signal driver circuit 1204d.

The fuse operating circuit 1204 may be configured to program the fuse 1202 by means of at least one of electromigration mode programming and rupture mode programming The fuse operating circuit 1204 may program the fuse 1202 by means of a programming pulse, which may, for example, be provided to the fuse 1202 by means of the coupling 1206.

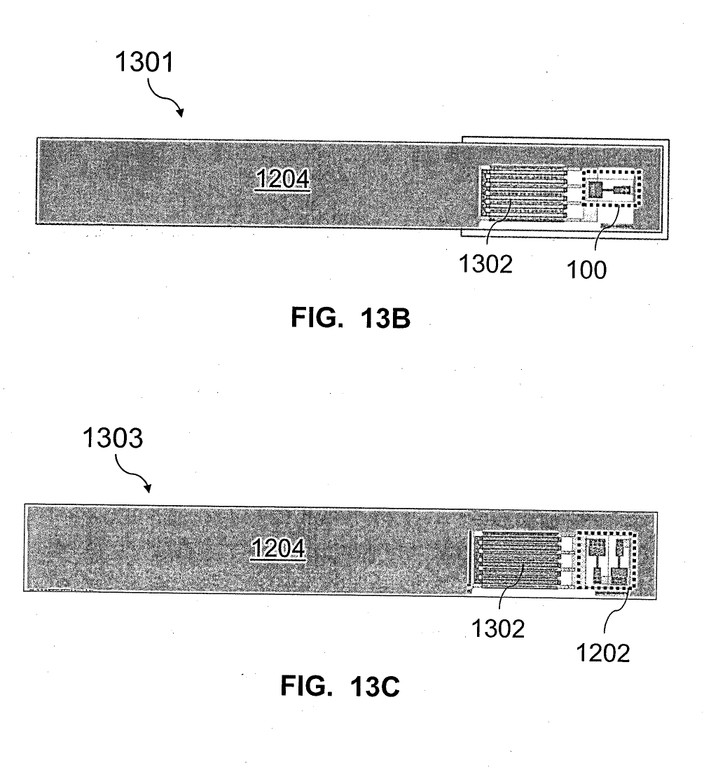

FIG. 13A shows a schematic plan view of a fuse element 1300 including a programming transistor 1302.

Reference signs in FIG. 13A that are the same as in FIG. 12 denote the same or similar elements as in FIG. 12. Thus, those elements will not be described in detail again here; reference is made to the description above.

As shown in FIG. 13A, the fuse element 1300 may include a fuse 1202 and a fuse operating circuit 1204. The fuse operating circuit 1204 may include the programming transistor 1302, which may be coupled to the first fuse link 502-1. The programming transistor 1302 may, e.g., be coupled to a first terminal region of the fuse 1202. The fuse operating circuit 1204 may include additional circuitry 1204b, e.g. at least one of a sensing circuit, a signal driver, a level shifter, etc., which may be coupled to the programming transistor 1302. The coupling between the programming transistor 1302 and the additional circuitry 1204b is indicated in FIG. 13 as coupling 1304.

The additional circuitry 1204b may be further coupled to the second fuse link 502-2. The additional circuitry 1204b may, e.g., be coupled to a second terminal region of the fuse 1302. Accordingly, the fuse 1202 may be programmed (e.g. by means of a programming pulse, e.g. provided by the programming transistor 1302) and a resistance of the fuse 1202 may be determined (e.g. sensed) by means of the additional circuitry 1204b, e.g. a sensing circuit 1204b included in the additional circuitry 1204b. Consequently, the fuse 1202 may be determined to be an unprogrammed fuse or a programmed fuse, e.g. by means of the additional circuitry 1204b, e.g. by the sensing circuit.

The fuse element 1300 shown in FIG. 13A may be configured as a 1-D eFuse library element using, e.g., two standard eFuse links, and may have only a small footprint increase compared to a standard eFuse library element. For example, FIG. 13B shows a fuse element 1301 which may be configured as a 1-D eFuse library element using a standard fuse (e.g. the conventional fuse 100 shown in FIG. 1). FIG. 13C shows a fuse element which may be configured as a 1-D eFuse library element using two standard fuse links (e.g. the first and second fuse links 502-1, 502-2 of the fuse 1202 shown in FIG. 13A). A comparison of FIG. 13B and FIG. 13C shows that the fuse element 1303 of FIG. 13C (using e.g. two standard fuse links, e.g. eFuse links) may have only a small footprint increase compared to the standard fuse library element of FIG. 13B.

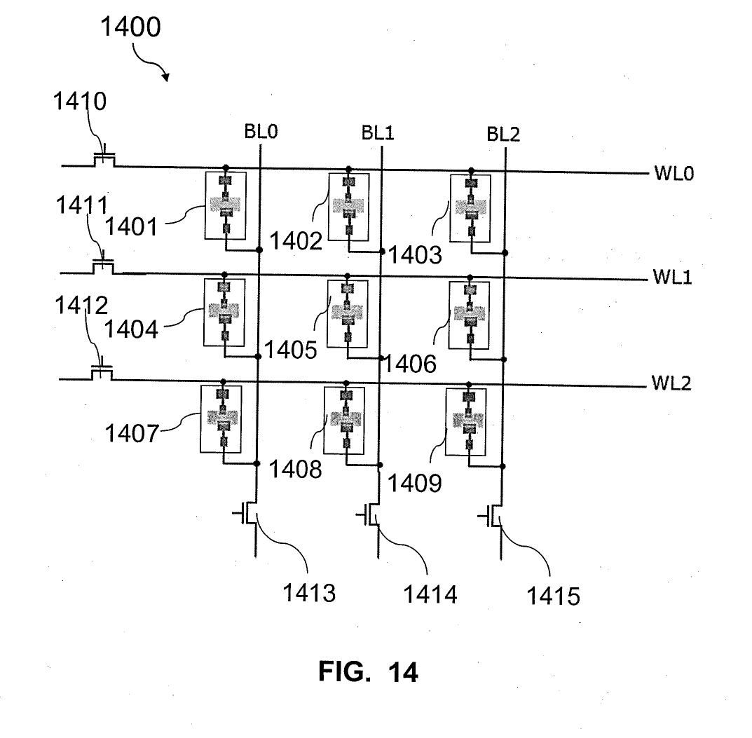

FIG. 14 shows a schematic plan view of a fuse array 1400.

The fuse array 1400 may include a plurality of first conductive lines (e.g. bit lines) BL0, BL1, BL2 and a plurality of second conductive lines (e.g. word lines) WL0, WL1, WL2. Only three first and second conductive lines are shown as an example. However, the number of first and second conductive lines may be greater than three and may, for example, be greater than or equal to five, e.g. greater than or equal to ten, greater than or equal to 20, etc.

The fuse array 1400 may include a plurality of fuses 1401 to 1409. Only nine fuses 1401 to 1409 are shown as an example. However, the number of fuses may be less than nine (e.g. two, three, four, five, six, seven, eight) or may be greater than nine and may, for example, be tens of fuses.

As shown in FIG. 14, a fuse of the plurality of fuses 1401 to 1409 may be, in each case, coupled between a respective one of the plurality of first conductive lines BL0, BL1, BL2 and a respective one of the plurality of second conductive lines WL0, WL1, WL2. For example, the fuse 1401 may be coupled between the first conductive line BL0 and the second conductive line WL0. By way of another example, the fuse 1405 may be coupled between the first conductive line BL1 and the second conductive line WL1. For example, a first terminal region of a respective fuse may be coupled to a respective first conductive line, and a second terminal region of the fuse may be coupled to a respective second conductive line. A fuse of the plurality of fuses 1401 to 1409 may be, in each case, arranged at a cross-point (e.g. an intersection) of a respective first conductive line and a respective second conductive line.

Each fuse of the plurality of fuses 1401 to 1409 may include a first fuse link and a second fuse link coupled in series to the first fuse link. For example, each fuse of the plurality of fuses 1401 to 1409 may include, or may be, at least one of the fuses 500, 800, 801, 803, 900, 1000, 1100, and 1101.

As shown in FIG. 14, the fuse array 1400 may include a plurality of selection devices 1410 to 1415 (e.g. a diode and/or a transistor) that may select a fuse of the plurality of fuses 1401 to 1409 by means of coupling a selected fuse to a respective first conductive line of the plurality of first conductive lines BL0, BL1, BL2 and a respective second conductive line of the plurality of second conductive lines WL0, WL1, WL2. For example, by enabling selection devices 1410 and 1413 shown in FIG. 14, fuse 1401 may be selected, and a programming current may be applied to program fuse 1401, or a sensing current may be applied to detect whether fuse 1401 is in an unprogrammed or programmed state, by means of programming and/or sensing circuitry coupled to the first and second conductive lines.

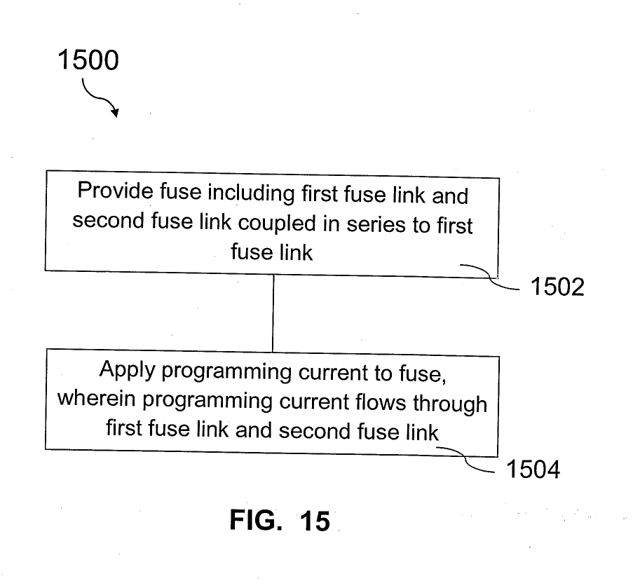

FIG. 15 shows a method 1500 for programming a fuse.

The method 1500 may include: providing a fuse including a first fuse link and a second fuse link coupled in series to the first fuse link (in 1502); and applying a programming current to the fuse, wherein the programming current flows through the first fuse link and the second fuse link (in 1504).

Applying the programming current to the fuse (in 1504) may include, or may consist of, applying a programming pulse having a predeterminable (or predetermined) pulse length and a constant current magnitude during the predeterminable (or predetermined) pulse length.

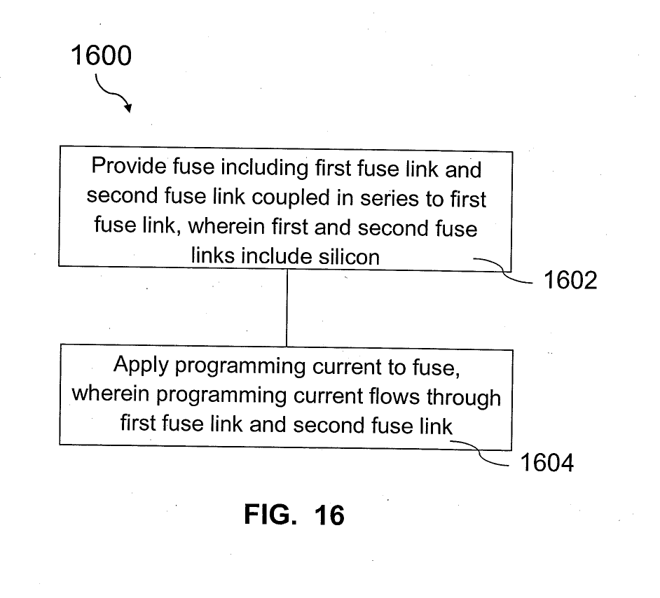

The fuse programmed according to the method 1500 may, for example, be at least one of the fuses 500, 800, 801, 803, 900, 1000, 1100, and 1101 described above. Accordingly, the methods shown in FIG. 16 to FIG. 19 may be provided.

FIG. 16 shows a method 1600 for programming a fuse according to an embodiment.

The method 1600 may include: providing a fuse including a first fuse link and a second fuse link coupled in series to the first fuse link, wherein the first and second fuse links includes, or consists of, silicon (in 1602); and applying a programming current to the fuse, wherein the programming current flows through the first fuse link and the second fuse link (in 1604).

As described above, the fuse programmed according to the method 1500 may, for example, be at least one of the fuses 500, 800, 801, 803, 900, 1000, 1100, and 1101. Accordingly, the second fuse link of method 1600 may be disposed in the same level as the first fuse link of method 1600.

The first and second fuse links of the method 1600 may include a polysilicon layer and a silicide layer at a surface of the polysilicon layer.

The fuse of method 1600 may further include: at least one non-fusable connection element coupled between the first and second fuse links, the connection element having a non-minimal feature size and being disposed in a metallization level at least one of above and below the first and second fuse links.

The first and second fuse links of method 1600 may be configured to have a lateral current flow.

The fuse of method 1600 may further include: a connection element coupled between the first and second fuse links, the connection element being disposed in a metallization level at least one of above and below the first and second fuse links.

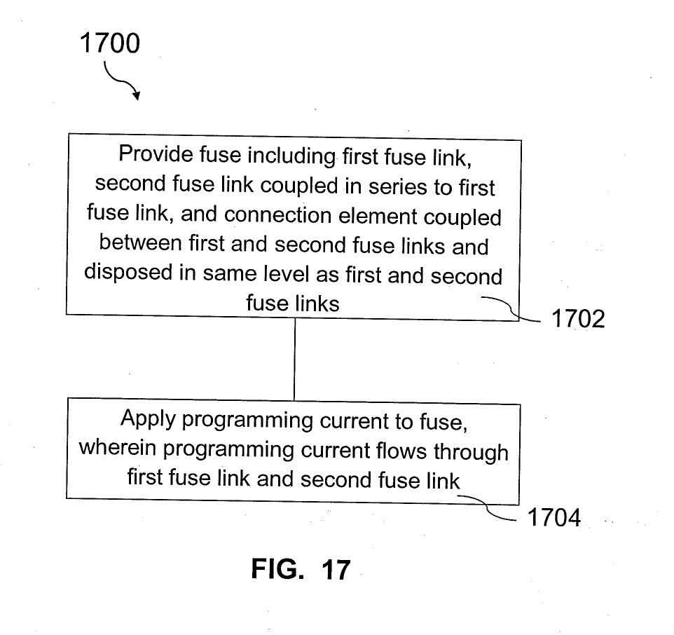

FIG. 17 shows a method 1700 for programming a fuse according to another embodiment.

The method 1700 may include: providing a fuse including a first fuse link, a second fuse link coupled in series to the first fuse link, and a connection element coupled between the first and second fuse links and disposed in the same level as the first and second fuse links (in 1702); and applying a programming current to the fuse, wherein the programming current flows through the first fuse link and the second fuse link (in 1704).

The first and second fuse links of method 1700 may include, or may consist of, silicon.

The first and second fuse links of method 1700 may include a polysilicon layer and a silicide layer at a surface of the polysilicon layer.

The connection element of method 1700 may be configured as a non-fusable connection element.

The connection element of method 1700 may have a non-minimal feature size.

The first and second fuse links of method 1700 may be configured to have a lateral current flow.

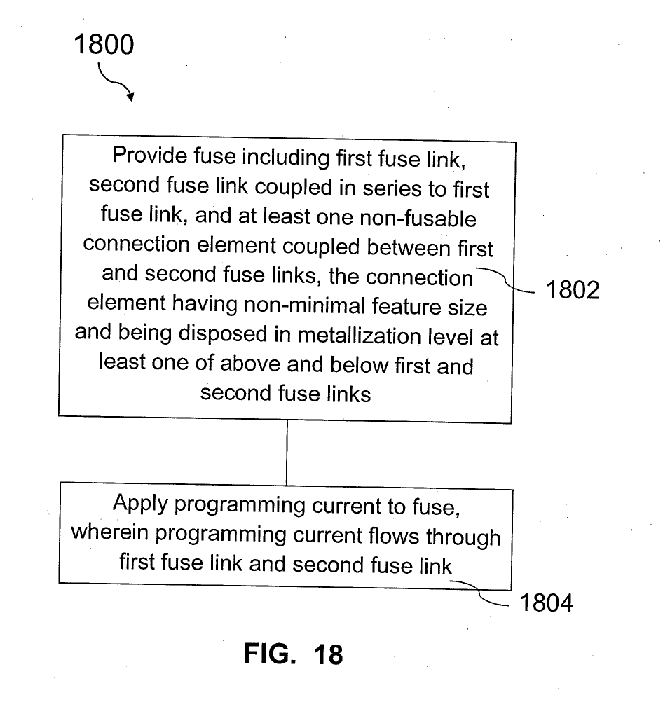

FIG. 18 shows a method 1800 for programming a fuse according to yet another embodiment.

The method 1800 may include: providing a fuse including a first fuse link, a second fuse link coupled in series to the first fuse link, and at least one non-fusable connection element coupled between the first and second fuse links, the connection element having a non-minimal feature size and being disposed in a metallization level at least one of above and below the first and second fuse links (in 1802); and applying a programming current to the fuse, wherein the programming current flows through the first fuse link and the second fuse link (in 1804).

The first and second fuse links of method 1800 may include, or may consist of, silicon.

The first and second fuse links of method 1800 may include a polysilicon layer and a silicide layer at a surface of the polysilicon layer.

The first and second fuse links of method 1800 may be configured to have a lateral current flow.

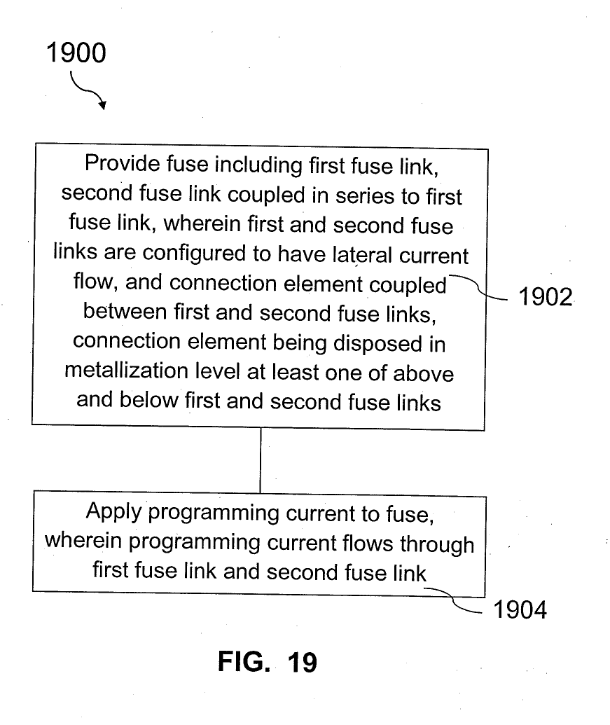

FIG. 19 shows a method 1900 for programming a fuse according to a further embodiment.

The method 1900 may include: providing a fuse including a first fuse link, a second fuse link coupled in series to the first fuse link, wherein the first and second fuse links are configured to have a lateral current flow, and a connection element coupled between the first and second fuse links, the connection element being disposed in a metallization level at least one of above and below the first and second fuse links (in 1902); and applying a programming current to the fuse, wherein the programming current flows through the first fuse link and the second fuse link (in 1904).

The first and second fuse links of method 1900 may include, or may consist of, silicon.

The first and second fuse links of method 1900 may include a polysilicon layer and a silicide layer at a surface of the polysilicon layer.

The connection element of method 1900 may be configured as a non-fusable connection element.

The connection element of method 1900 may have a non-minimal feature size.

According to various examples presented herein, only one programming pulse may be used to program a fuse including first and second fuse links 502-1, 502-2 coupled in series.

According to various examples presented herein, the programming time and/or test time of a fuse including first and second fuse links coupled in series may be at least substantially equal to the programming time and/or test time of a single conventional fuse (e.g. the conventional fuse 100).

According to various examples presented herein, there may a negligible increase in area occupied by a fuse including first and second fuse links coupled in series compared to a single conventional fuse (e.g. the conventional fuse 100).

According to various examples presented herein, Error Correction Code (ECC) schemes may not need to be provided for a fuse including first and second fuse links coupled in series, thus reducing an area occupied by the fuse.

According to various examples presented herein, a fuse including first and second fuse links coupled in series may be used in every technology offering polysilicon fuses (e.g. polysilicon e-fuses).

According to various examples presented herein, a plurality of fuses, each including first and second fuse links coupled in series may be arranged in one- and/or two-dimensional arrangements.

According to various examples presented herein, a fuse including first and second fuse links coupled in series may include at least one of p-doped, n-doped, and undoped polysilicon.

According to various examples presented herein, a fuse may be provided. The fuse may include a first fuse link; a second fuse link coupled in series to the first fuse link, wherein at least one of the first and second fuse links includes, or consists of, polysilicon.

The first and second fuse links may be disposed in the same level.

The first and second fuse links may be configured to have a lateral current flow.

The first and second fuse links may be disposed in a polysilicon level of the fuse.

The fuse may further include a first terminal region and a second terminal region, wherein the first and second fuse links may be coupled between the first and second terminal regions.

A cross-sectional area of the first terminal region may be larger than a cross-sectional area of the first fuse link, and a cross-sectional area of the second terminal region may be larger than a cross-sectional area of the second fuse link.

A width of the first terminal region may be wider than a width of the first fuse link, and a width of the second terminal region may be wider than a width of the second fuse link.

The fuse may further include at least one connection element coupled between the first and second fuse links.

The at least one connection element may be disposed in the same level as the first and second fuse links.

The at least one connection element may be disposed in a different level than the first and second fuse links.

The at least one connection element may be disposed in a metallization level at least one of above and below the first and second fuse links.

The at least one connection element may include, or may be, a non-fusable connection element.

The at least one connection element may have a non-minimal feature size.

A cross-sectional area of the at least one connection element may be larger than a cross-sectional area of the first fuse link and larger than a cross-sectional area of the second fuse link.

A width of the at least one connection element may be wider than a width of the first fuse link and wider than a width of the second fuse link.

The at least one connection element may be configured to have a lateral current flow.

The fuse may further include a first terminal region; a second terminal region; and at least one connection element, wherein the first fuse link may be coupled between the first terminal region and the at least one connection element, and wherein the second fuse link may be coupled between the at least one connection element and the second terminal region.

A width of the first terminal region, a width of the second terminal region, and a width of the at least one connection element may be wider than a width of the first fuse link and a width of the second fuse link.

A first end of the first fuse link may abut the first terminal region, wherein a second end of the first fuse link may abut a first side of the at least one connection element, wherein a first end of the second fuse link may abut a second side of the at least one connection element, and wherein a second end of the second fuse link may abut the second terminal region.

The first and second terminal regions and the at least one connection element may be made of the same material as the first and second fuse links.

The fuse may further include at least one additional fuse link coupled in series to the second fuse link.

The at least one of the first and second fuse links may include, or may consist of, a polysilicon layer and a silicide layer at a surface of the polysilicon layer.

The polysilicon may include, or may be, doped polysilicon.

The first and second fuse links may include, or may consist of, polysilicon, and wherein the polysilicon of one of the first and second fuse links may include, or may consist of, doped polysilicon and the polysilicon of the other one of the first and second fuse links may include, or may consist of, undoped polysilicon.

The first and second fuse links may include, or may consist of, polysilicon, and wherein the polysilicon of one of the first and second fuse links may include, or may consist of, n-doped polysilicon and the polysilicon of the other one of the first and second fuse links may include, or may consist of, p-doped polysilicon.

According to various examples presented herein a fuse may be provided. The fuse may include a first fuse link; a second fuse link coupled in series to the first fuse link; and a connection element coupled between the first and second fuse links and disposed in the same level as the first and second fuse links.

The first and second fuse links may be configured to have a lateral current flow.

The connection element may be configured as a non-fusable connection element.

The connection element may have a non-minimal feature size.

A cross-sectional area of the connection element may be larger than a cross-sectional area of the first fuse link and larger than a cross-sectional area of the second fuse link.

A width of the connection element may be wider than a width of the first fuse link and wider than a width of the second fuse link.

The connection element may be configured to have a lateral current flow.

The fuse may further include a first terminal region and a second terminal region, wherein the first fuse link, the second fuse link, and the connection element may be coupled between the first and second terminal regions.

A cross-sectional area of the first terminal region may be larger than a cross-sectional area of the first fuse link, and wherein a cross-sectional area of the second terminal region may be larger than a cross-sectional area of the second fuse link.

A width of the first terminal region may be wider than a width of the first fuse link, and wherein a width of the second terminal region may be wider than a width of the second fuse link.

The first and second terminal regions and the at least one connection element may be made of the same material as the first and second fuse links.

A first end of the first fuse link may abut the first terminal region, wherein a second end of the first fuse link may abut a first side of the connection element, wherein a first end of the second fuse link may abut a second side of the connection element, and wherein a second end of the second fuse link may abut the second terminal region.

The fuse may further include at least one additional fuse link coupled in series to the second fuse link.

At least one of the first and second fuse links may include, or may consist of, polysilicon.

At least one of the first and second fuse links may include, or may consist of, a polysilicon layer and a silicide layer at a surface of the polysilicon layer.

The polysilicon may include, or may be, doped polysilicon.

At least one of the first and second fuse links may include, or may consist of, a metal or metal alloy.

At least one of the first and second fuse links may include, or may consist of, a metal or metal alloy layer and a liner at a surface of the metal or metal alloy layer.

The first and second fuse links may include, or may consist of, polysilicon, and wherein the polysilicon of one of the first and second fuse links may include, or may consist of, doped polysilicon and the polysilicon of the other one of the first and second fuse links may include, or may consist of, undoped polysilicon.

The first and second fuse links may include, or may consist of, polysilicon, and wherein the polysilicon of one of the first and second fuse links may include, or may consist of, n-doped polysilicon and the polysilicon of the other one of the first and second fuse links may include, or may consist of, p-doped polysilicon.

According to various examples presented herein, a fuse may be provided. The fuse may include a first fuse link; a second fuse link coupled in series to the first fuse link; and at least one non-fusable connection element coupled between the first and second fuse links, the connection element having a non-minimal feature size and being disposed in a metallization level at least one of above and below the first and second fuse links.

The first and second fuse links may be disposed in the same level.

The first and second fuse links may be configured to have a lateral current flow.

A cross-sectional area of the at least one non-fusable connection element may be larger than a cross-sectional area of the first fuse link and larger than a cross-sectional area of the second fuse link.

A width of the at least one non-fusable connection element may be wider than a width of the first fuse link and wider than a width of the second fuse link.

The connection element may be configured to have a lateral current flow.

The fuse may further include a first terminal region and a second terminal region, wherein the first fuse link, the second fuse link, and the at least one non-fusable connection element may be coupled between the first and second terminal regions.

A cross-sectional area of the first terminal region may be larger than a cross-sectional area of the first fuse link, and wherein a cross-sectional area of the second terminal region may be larger than a cross-sectional area of the second fuse link.

A width of the first terminal region may be wider than a width of the first fuse link, and wherein a width of the second terminal region may be wider than a width of the second fuse link.

The first and second terminal regions may be made of the same material as the first and second fuse links.

The fuse may further include at least one additional fuse link coupled in series to the second fuse link.

At least one of the first and second fuse links may include, or may consist of, polysilicon.

At least one of the first and second fuse links may include, or may consist of, a polysilicon layer and a silicide layer at a surface of the polysilicon layer.

The polysilicon may include, or may be, doped polysilicon.

At least one of the first and second fuse links may include, or may consist of, a metal or metal alloy.

At least one of the first and second fuse links may include, or may consist of, a metal or metal alloy layer and a liner at a surface of the metal or metal alloy layer.

The first and second fuse links may include, or may consist of, polysilicon, and wherein the polysilicon of one of the first and second fuse links may include, or may consist of, doped polysilicon and the polysilicon of the other one of the first and second fuse links may include, or may consist of, undoped polysilicon.

The first and second fuse links may include, or may consist of, polysilicon, and wherein the polysilicon of one of the first and second fuse links may include, or may consist of, n-doped polysilicon and the polysilicon of the other one of the first and second fuse links may include, or may consist of, p-doped polysilicon.

According to various examples presented herein, a fuse may be provided. The fuse may include a first fuse link; a second fuse link coupled in series to the first fuse link, wherein the first and second fuse links are configured to have a lateral current flow; and a connection element coupled between the first and second fuse links, the connection element being disposed in a metallization level at least one of above and below the first and second fuse links.

The first and second fuse links may be disposed in the same level.

A cross-sectional area of the connection element may be larger than a cross-sectional area of the first fuse link and larger than a cross-sectional area of the second fuse link.

A width of the connection element may be wider than a width of the first fuse link and wider than a width of the second fuse link.

The fuse may further include a first terminal region and a second terminal region, wherein the first fuse link, the second fuse link, and the connection element may be coupled between the first and second terminal regions.

A cross-sectional area of the first terminal region may be larger than a cross-sectional area of the first fuse link, and wherein a cross-sectional area of the second terminal region may be larger than a cross-sectional area of the second fuse link.

A width of the first terminal region may be wider than a width of the first fuse link, and wherein a width of the second terminal region may be wider than a width of the second fuse link.

The first and second terminal regions may be made of the same material as the first and second fuse links.

The fuse may further include at least one additional fuse link coupled in series to the second fuse link.

At least one of the first and second fuse links may include, or may consist of, polysilicon.

At least one of the first and second fuse links may include, or may consist of, a polysilicon layer and a silicide layer at a surface of the polysilicon layer.

The polysilicon may include, or may be, doped polysilicon.

At least one of the first and second fuse links may include, or may consist of, a metal or metal alloy.

At least one of the first and second fuse links may include, or may consist of, a metal or metal alloy layer and a liner at a surface of the metal or metal alloy layer.

The first and second fuse links may include, or may consist of, polysilicon, and wherein the polysilicon of one of the first and second fuse links may include, or may consist of, doped polysilicon and the polysilicon of the other one of the first and second fuse links may include, or may consist of, undoped polysilicon.

The first and second fuse links may include, or may consist of, polysilicon, and wherein the polysilicon of one of the first and second fuse links may include, or may consist of, n-doped polysilicon and the polysilicon of the other one of the first and second fuse links may include, or may consist of, p-doped polysilicon.

According to various examples presented herein, a fuse element may be provided. The fuse element may include a fuse, including: a first fuse link; a second fuse link coupled in series to the first fuse link, wherein at least one of the first and second fuse links may include, or may consist of, polysilicon; and a fuse operating circuit coupled to the fuse.

The first and second fuse links may be disposed in the same level.

The fuse of the fuse element may further include a connection element coupled between the first and second fuse links and disposed in the same level as the first and second fuse links.

The fuse of the fuse element may further include at least one non-fusable connection element coupled between the first and second fuse links, the connection element having a non-minimal feature size and being disposed in a metallization level at least one of above and below the first and second fuse links.

The fuse of the fuse element may further include a connection element coupled between the first and second fuse links, the connection element being disposed in a metallization level at least one above and below the fuse links.

The fuse operating circuit may include, or may be, at least one of: a programming circuit, a sensing circuit, a level shifting circuit, a signal driver circuit.

The fuse operating circuit may be configured to program the fuse by means of electromigration mode programming.

The fuse operating circuit may be configured to program the fuse by means of rupture mode programming.

According to various examples presented herein, a fuse element may be provided. The fuse element may include a fuse, including: a first fuse link; a second fuse link coupled in series to the first fuse link; and a connection element coupled between the first and second fuse links and disposed in the same level as the first and second fuse links; and a fuse operating circuit coupled to the fuse.

The first and second fuse links may be configured to have a lateral current flow.

The connection element may be configured as a non-fusable connection element.

The connection element may have a non-minimal feature size.

A cross-sectional area of the connection element may be larger than a cross-sectional area of the first fuse link and larger than a cross-sectional area of the second fuse link.

A width of the connection element may be wider than a width of the first fuse link and wider than a width of the second fuse link.

The connection element may be configured to have a lateral current flow.

The fuse element may further include: a first terminal region and a second terminal region, wherein the first fuse link, the second fuse link, and the connection element are coupled between the first and second terminal regions.

A cross-sectional area of the first terminal region may be larger than a cross-sectional area of the first fuse link, and wherein a cross-sectional area of the second terminal region may be larger than a cross-sectional area of the second fuse link.

A width of the first terminal region may be wider than a width of the first fuse link, and wherein a width of the second terminal region may be wider than a width of the second fuse link.

The first and second terminal regions and the at least one connection element may be made of the same material as the first and second fuse links.

A first end of the first fuse link may abut the first terminal region, wherein a second end of the first fuse link may abut a first side of the connection element, wherein a first end of the second fuse link may abut a second side of the connection element, and wherein a second end of the second fuse link may abut the second terminal region.

The fuse element may further include at least one additional fuse link coupled in series to the second fuse link.

At least one of the first and second fuse links may include, or may consist of, polysilicon.

At least one of the first and second fuse links may include, or may consist of, a polysilicon layer and a silicide layer at a surface of the polysilicon layer.

The polysilicon may include, or may be, doped polysilicon.

At least one of the first and second fuse links may include, or may consist of, a metal or metal alloy.

At least one of the first and second fuse links may include, or may consist of, a metal or metal alloy layer and a liner at a surface of the metal or metal alloy layer.

The first and second fuse links may include, or may consist of, polysilicon, and wherein the polysilicon of one of the first and second fuse links may include, or may consist of, doped polysilicon and the polysilicon of the other one of the first and second fuse links may include, or may consist of, undoped polysilicon.

The first and second fuse links may include, or may consist of, polysilicon, and wherein the polysilicon of one of the first and second fuse links may include, or may consist of, n-doped polysilicon and the polysilicon of the other one of the first and second fuse links may include, or may consist of, p-doped polysilicon.

According to various examples presented herein, a fuse element may be provided. The fuse element may include a fuse, including: a first fuse link; a second fuse link coupled in series to the first fuse link; and at least one non-fusable connection element coupled between the first and second fuse links, the connection element having a non-minimal feature size and being disposed in a metallization level at least one of above and below the first and second fuse links; and a fuse operating circuit coupled to the fuse.

The first and second fuse links may be disposed in the same level.

The first and second fuse links may be configured to have a lateral current flow.

A cross-sectional area of the at least one non-fusable connection element may be larger than a cross-sectional area of the first fuse link and larger than a cross-sectional area of the second fuse link.

A width of the at least one non-fusable connection element may be wider than a width of the first fuse link and wider than a width of the second fuse link.

The connection element may be configured to have a lateral current flow.

The fuse element may further include a first terminal region and a second terminal region, wherein the first fuse link, the second fuse link, and the at least one non-fusable connection element may be coupled between the first and second terminal regions.

A cross-sectional area of the first terminal region may be larger than a cross-sectional area of the first fuse link, and wherein a cross-sectional area of the second terminal region may be larger than a cross-sectional area of the second fuse link.

A width of the first terminal region may be wider than a width of the first fuse link, and wherein a width of the second terminal region may be wider than a width of the second fuse link.

The first and second terminal regions may be made of the same material as the first and second fuse links.

The fuse element may further include at least one additional fuse link coupled in series to the second fuse link.

At least one of the first and second fuse links may include, or may consist of, polysilicon.

At least one of the first and second fuse links may include, or may consist of, a polysilicon layer and a silicide layer at a surface of the polysilicon layer.

The polysilicon may include, or may be, doped polysilicon.

At least one of the first and second fuse links may include, or may consist of, a metal or metal alloy.

At least one of the first and second fuse links may include, or may consist of, a metal or metal alloy layer and a liner at a surface of the metal or metal alloy layer.

The first and second fuse links may include, or may consist of, polysilicon, and wherein the polysilicon of one of the first and second fuse links may include, or may consist of, doped polysilicon and the polysilicon of the other one of the first and second fuse links may include, or may consist of, undoped polysilicon.

The first and second fuse links may include, or may consist of, polysilicon, and wherein the polysilicon of one of the first and second fuse links may include, or may consist of, n-doped polysilicon and the polysilicon of the other one of the first and second fuse links may include, or may consist of, p-doped polysilicon.

According to various examples presented herein, a fuse element may be provided. The fuse element may include a fuse, including: a first fuse link; a second fuse link coupled in series to the first fuse link, wherein the first and second fuse links are configured to have a lateral current flow; and a connection element coupled between the first and second fuse links, the connection element being disposed in a metallization level at least one of above and below the first and second fuse links; and a fuse operating circuit coupled to the fuse.

The first and second fuse links may be disposed in the same level.

A cross-sectional area of the connection element may be larger than a cross-sectional area of the first fuse link and larger than a cross-sectional area of the second fuse link.

A width of the connection element may be wider than a width of the first fuse link and wider than a width of the second fuse link.

The fuse element may further include a first terminal region and a second terminal region, wherein the first fuse link, the second fuse link, and the connection element may be coupled between the first and second terminal regions.

A cross-sectional area of the first terminal region may be larger than a cross-sectional area of the first fuse link, and wherein a cross-sectional area of the second terminal region may be larger than a cross-sectional area of the second fuse link.

A width of the first terminal region may be wider than a width of the first fuse link, and wherein a width of the second terminal region may be wider than a width of the second fuse link.

The first and second terminal regions may be made of the same material as the first and second fuse links.

The fuse element may further include at least one additional fuse link coupled in series to the second fuse link.

At least one of the first and second fuse links may include, or may consist of, polysilicon.

At least one of the first and second fuse links may include, or may consist of, a polysilicon layer and a silicide layer at a surface of the polysilicon layer.

The polysilicon may include, or may be, doped polysilicon.

At least one of the first and second fuse links may include, or may consist of, a metal or metal alloy.

At least one of the first and second fuse links may include, or may consist of, a metal or metal alloy layer and a liner at a surface of the metal or metal alloy layer.

The first and second fuse links may include, or may consist of, polysilicon, and wherein the polysilicon of one of the first and second fuse links may include, or may consist of, doped polysilicon and the polysilicon of the other one of the first and second fuse links may include, or may consist of, undoped polysilicon.

The first and second fuse links may include, or may consist of, polysilicon, and wherein the polysilicon of one of the first and second fuse links may include, or may consist of, n-doped polysilicon and the polysilicon of the other one of the first and second fuse links may include, or may consist of, p-doped polysilicon.

According to various examples presented herein, a fuse array may be provided. The fuse array may include a plurality of first conductive lines and a plurality of second conductive lines; a plurality of fuses, a fuse of the plurality of fuses being in each case coupled between a respective one of the plurality of first conductive lines and a respective one of the plurality of second conductive lines, wherein each fuse may include a first fuse link and a second second fuse link coupled in series to the first fuse link

The second fuse link may be disposed in the same level as the first fuse link.

At least one of the first and second fuse links may include, or may consist of, polysilicon.

The fuse of the fuse array may further include a connection element coupled between the first and second fuse links and disposed in the same level as the first and second fuse links.

The fuse of the fuse array may further include a connection element coupled between the first and second fuse links, the connection element being disposed in a metallization level at least one above and below the fuse links.

The fuse of the fuse array may further include at least one non-fusable connection element coupled between the first and second fuse links, the connection element having a non-minimal feature size and being disposed in a metallization level at least one of above and below the first and second fuse links.

Each fuse of the fuse array may further include a first terminal region coupled between the first fuse link and the respective first conductive line, and a second terminal region coupled between the second fuse link and the respective second conductive line, wherein a cross-sectional area of the first terminal region is larger than a cross-sectional area of the first fuse link, and wherein a cross-sectional area of the second terminal region is larger than a cross-sectional area of the second fuse link.

Each fuse of the fuse array may further include at least one connection element coupled between the first and second fuse links, wherein a cross-sectional area of the at least one connection element is larger than a cross-sectional area of the first fuse link and larger than a cross-sectional area of the second fuse link.

According to various embodiments, a method for programming a fuse may be provided. The method may include: providing a fuse including a first fuse link and a second fuse link coupled in series to the first fuse link, wherein the first and second fuse links include silicon; and applying a programming current to the fuse, wherein the programming current flows through the first fuse link and the second fuse link.

Applying the programming current to the fuse may include applying a programming pulse having a predeterminable pulse length and a constant current magnitude during the predeterminable pulse length.

The second fuse link may be disposed in the same level as the first fuse link.

The first and second fuse links may include a polysilicon layer and a silicide layer at a surface of the polysilicon layer.

The fuse may further include: at least one non-fusable connection element coupled between the first and second fuse links, the connection element having a non-minimal feature size and being disposed in a metallization level at least one of above and below the first and second fuse links.

The first and second fuse links may be configured to have a lateral current flow.

The fuse may further include a connection element coupled between the first and second fuse links, the connection element being disposed in a metallization level at least one of above and below the first and second fuse links.

According to various embodiments, a method for programming a fuse may be provided. The method may include: providing a fuse including a first fuse link, a second fuse link coupled in series to the first fuse link, and a connection element coupled between the first and second fuse links and disposed in the same level as the first and second fuse links; and applying a programming current to the fuse, wherein the programming current flows through the first fuse link and the second fuse link.

Applying the programming current to the fuse may include applying a programming pulse having a predeterminable pulse length and a constant current magnitude during the predeterminable pulse length.

The first and second fuse links may include silicon.

The first and second fuse links may include a polysilicon layer and a silicide layer at a surface of the polysilicon layer.

The connection element may be configured as a non-fusable connection element.

The connection element may have a non-minimal feature size.

The first and second fuse links may be configured to have a lateral current flow.

According to various embodiments, a method for programming a fuse may be provided. The method may include: providing a fuse including a first fuse link, a second fuse link coupled in series to the first fuse link, and at least one non-fusable connection element coupled between the first and second fuse links, the connection element having a non-minimal feature size and being disposed in a metallization level at least one of above and below the first and second fuse links; and applying a programming current to the fuse, wherein the programming current flows through the first fuse link and the second fuse link.

Applying the programming current to the fuse may include applying a programming pulse having a predeterminable pulse length and a constant current magnitude during the predeterminable pulse length.

The first and second fuse links may include silicon.

The first and second fuse links may include a polysilicon layer and a silicide layer at a surface of the polysilicon layer.

The first and second fuse links may be configured to have a lateral current flow.

According to various embodiments, a method for programming a fuse may be provided. The method may include: providing a fuse including a first fuse link, a second fuse link coupled in series to the first fuse link, wherein the first and second fuse links are configured to have a lateral current flow, and a connection element coupled between the first and second fuse links, the connection element being disposed in a metallization level at least one of above and below the first and second fuse links; and applying a programming current to the fuse, wherein the programming current flows through the first fuse link and the second fuse link.

Applying the programming current to the fuse may include applying a programming pulse having a predeterminable pulse length and a constant current magnitude during the predeterminable pulse length.

The first and second fuse links may include silicon.

The first and second fuse links may include a polysilicon layer and a silicide layer at a surface of the polysilicon layer.

The connection element may be configured as a non-fusable connection element.

The connection element may have a non-minimal feature size.

Various examples and aspects described in the context of one of the devices (e.g. fuses, fuse elements, fuse arrays) and/or methods (e.g. of programming a fuse) described herein may be analogously valid for the other devices (e.g. fuses, fuse elements, fuse arrays) and/or methods (e.g. of programming a fuse) described herein.

While various aspects have been particularly shown and described with reference to these aspects of this disclosure, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced.

What is claimed is:

1. A fuse, comprising:
a first fuse link;
a second fuse link coupled in series to the first fuse link; and
a connection element coupled between the first and second fuse links and disposed in the same level as the first and second fuse links.

2. The fuse of claim 1, wherein the connection element has a non-minimal feature size.

3. The fuse of claim 1, wherein a cross-sectional area of the connection element is larger than a cross-sectional area of the first fuse link and larger than a cross-sectional area of the second fuse link.

4. The fuse of claim 1, further comprising:
a first terminal region and a second terminal region,
wherein the first fuse link, the second fuse link, and the connection element are coupled between the first and second terminal regions.

5. The fuse of claim 1, further comprising at least one additional fuse link coupled in series to the second fuse link.

6. The fuse of claim 1, wherein at least one of the first and second fuse links comprises polysilicon.

7. A fuse, comprising:
a first fuse link;
a second fuse link coupled in series to the first fuse link,
wherein at least one of the first and second fuse links comprises polysilicon.

8. The fuse of claim 7, further comprising:
a first terminal region and a second terminal region,
wherein the first and second fuse links are coupled between the first and second terminal regions.

9. The fuse of claim 8, wherein a cross-sectional area of the first terminal region is larger than a cross-sectional area of the first fuse link, and wherein a cross-sectional area of the second terminal region is larger than a cross-sectional area of the second fuse link.

10. The fuse of claim 7, further comprising:
at least one connection element coupled between the first and second fuse links.

11. The fuse of claim 10, wherein the at least one connection element is disposed in the same level as the first and second fuse links.

12. The fuse of claim 10, wherein the at least one connection element is disposed in a different level than the first and second fuse links.

13. The fuse of claim 10, wherein the at least one connection element is disposed in a metallization level at least one of above and below the first and second fuse links.

14. The fuse of claim 7, wherein the at least one of the first and second fuse links comprises a polysilicon layer and a silicide layer at a surface of the polysilicon layer.

15. The fuse of claim 7, wherein the first and second fuse links comprise polysilicon, and wherein the polysilicon of one of the first and second fuse links comprises doped polysilicon and the polysilicon of the other one of the first and second fuse links comprises undoped polysilicon.

16. The fuse of claim 7, wherein the first and second fuse links comprise polysilicon, and wherein the polysilicon of one of the first and second fuse links comprises n-doped polysilicon and the polysilicon of the other one of the first and second fuse links comprises p-doped polysilicon.

17. A fuse, comprising:
a first fuse link;
a second fuse link coupled in series to the first fuse link; and
at least one non-fusable connection element coupled between the first and second fuse links, the connection element having a non-minimal feature size and being disposed in a metallization level at least one of above and below the first and second fuse links.

18. The fuse of claim 17, wherein a cross-sectional area of the at least one non-fusable connection element is larger than a cross-sectional area of the first fuse link and larger than a cross-sectional area of the second fuse link.

19. The fuse of claim 17, wherein the connection element is configured to have a lateral current flow.

20. The fuse of claim 17, further comprising:
a first terminal region and a second terminal region,
wherein the first fuse link, the second fuse link, and the at least one non-fusable connection element are coupled between the first and second terminal regions.

21. The fuse of claim 20, wherein a cross-sectional area of the first terminal region is larger than a cross-sectional area of the first fuse link, and wherein a cross-sectional area of the second terminal region is larger than a cross-sectional area of the second fuse link.

22. A fuse, comprising:
a first fuse link;
a second fuse link coupled in series to the first fuse link, wherein the first and second fuse links are configured to have a lateral current flow; and
a connection element coupled between the first and second fuse links, the connection element being disposed in a metallization level at least one of above and below the first and second fuse links.

23. The fuse of claim 22, wherein the first and second fuse links are disposed in the same level.

24. The fuse of claim 22, wherein a cross-sectional area of the connection element is larger than a cross-sectional area of the first fuse link and larger than a cross-sectional area of the second fuse link.

25. The fuse of claim 22, wherein at least one of the first and second fuse links comprises polysilicon.
